(19) United States
(12) Patent Application Publication
(10) Pub. No.: US 2007/0288304 A1
(43) Pub. Date: Dec. 13, 2007

(54) SYSTEM AND METHOD FOR BEHAVIORALLY TARGETED ELECTRONIC COMMUNICATIONS

(75) Inventors: Chris Gutierrez, Overland Park, KS (US); Jingying Zhang, Mission, KS (US)

Correspondence Address: LATHROP & GAGE LC, 2345 GRAND AVENUE, SUITE 2800, KANSAS CITY, MO, 64108, US

(73) Assignee: ADKNOWLEDGE, INC., Kansas City, MO (US)

(21) Appl. No.: 11/774,066

(22) Filed: Jul. 6, 2007

Related U.S. Application Data
(63) Continuation-in-part of application No. 11/449,306, filed on Jun. 8, 2006.

(51) Int. Cl. G06Q 30/00

(52) U.S. Cl. 705/10

(57) ABSTRACT

Methods and systems for determining the correlation between electronic informational campaigns, for example, two advertising campaigns, and then determining the particular campaign for a user, by a three phase process, based on the behavior of multiple users, are disclosed. In a first phase, probabilities of one campaign, with respect to another campaign, are calculated, and values of expected revenue for each campaign are determined from the probabilities. The campaigns with the greatest expected revenues are then analyzed, to determine the extent of their correlation, in the second phase. In the second phase, the correlation between two campaigns is determined, by determining a correlation value, indicative of the correlation between two campaigns. In a third phase, the correlation is factored by a user interest score, to determine a ranked order of campaigns for a particular user.

### RELATED APPLICATIONS

This application is a continuation-in-part application of commonly owned U.S. patent application Ser. No. 11/449,306, filed Jun. 8, 2006, entitled: SYSTEM AND METHOD FOR BEHAVIORALLY TARGETING ELECTRONIC COMMUNICATIONS, the disclosure of which is incorporated by reference herein.

### REFERENCE TO LARGE TABLE APPENDIX

This specification is accompanied by a Large Table Appendix, provided in the attached CD-R (CD-ROM) in ASCII characters. This CD-R is submitted herewith as Appendix A, in duplicate. Appendix A includes an electronic file entitled Table 1.txt, created Jun. 6, 2006, which is 329 KB. Appendix A is incorporated by reference herein, as though fully replicated herein.

### TECHNICAL FIELD

The present disclosed subject matter is directed to the field of the electronic communications over wide area public networks, such as the Internet, and, in particular, to determine the various users to send electronic communications, based on their responses to previously sent electronic communications.

### BACKGROUND

Advertising on the Internet is growing at rapid rate. Through 2007, it is expected that companies will allocate up to twenty-five percent of their advertising budget for Internet advertising. Internet advertising is typically accomplished through advertisements placed into web pages, pop-ups and banners. It is also achieved through electronic mail, commonly referred to as, e-mail. One method of sending advertising over electronic mail is disclosed in commonly owned U.S. patent application Ser. No. 10/915,975, entitled: Method And System For Dynamically Generating Electronic Communications (U.S. Patent Application Publication No. 2005/0038861 A1), this patent application and Patent Application Publication, are incorporated by reference herein. U.S. patent application Ser. No. 10/915,975, entitled: Method And System For Dynamically Generating Electronic Communications and U.S. Patent Application Publication No. 2005/0038861 A1, are used interchangeably herein.

As potential customers respond to Internet advertisements, the advertisers seek ways in which they can keep a captive customer's attention, to sell them other products, that they may also be interested in. In other words, Internet advertisements are targeted to specific groups based on their online interactions, as they travel within a web site or between multiple web sites. This is known as behavioral targeting.

Behavioral targeting is a practice that allows marketers to segment their audience into manageable groups, to deliver the right message to the right person at the right time. It also allows for the better management of the relationship between the marketer and their customers. Behavioral targeting utilizes integrated data from various sources to create a comprehensive profile of a customer that can be targeted using numerous delivery mechanisms.

For example, a person who responds to an advertisement for a gym, may also be receptive to advertisements for organic foods. Advertisers see behavioral targeting as a growth area, for it allows them to market to a smaller circle of customers, but these customers are more likely to buy the goods or services, than randomly sending or placing an advertisement on the Internet.

A major disadvantage to contemporary behavioral targeted Internet advertising is that it uses cookies. Cookies are information that a targeted web site puts on a user's hard disk so that it can remember something about the user at a later time. Specifically, cookies are information for future use that are stored by a server on the client side of a client/server communication. Typically, a cookie records a user's preferences when using a particular site. Using the Web's Hypertext Transfer Protocol (HTTP), each request for a Web page is independent of all other requests. For this reason, the Web page server has no memory of what pages it has sent to a user previously or anything about your previous visits.

Cookies serve as mechanisms that allow servers to store information about a user on the user's own computer. Users can view the cookies that have been stored on their hard disk. The location of the cookies depends on the browser or browsing application. Internet Explorer® stores each cookie as a separate file under a Windows subdirectory. Netscape® stores all cookies in a single cookies.txt file. Opera® stores them in a single cookies data file.

Cookies are commonly used to rotate banner ads that a web site sends to a user, so it does not keep sending the user the same banner advertisement for each of the user's requested web pages. Cookies can also be used to customize web pages for particular users, based the user's browser type or other information, the user provided to the Web site. Web users must agree to let cookies be saved for them, but, in general, it helps Web sites to serve users better.

However, most online users do not view cookies favorably. Rather, cookies are viewed as an invasion of privacy. Moreover, these users take great measures to eliminate cookies on the web browsers, deleting cookies that come onto their Web browser frequently, and in many cases, daily.

### SUMMARY OF THE DISCLOSED SUBJECT MATTER

The present disclosed subject matter provides systems and methods for behavioral targeting customers, users or recipients (customers, users and recipients being used interchangeably in this document) in order to send them information or advertising, to which they will be responsive. The system achieves its objectives, typically without cookies.

The invention typically involves a two or three phase process. It is based on user's behavior in responding to various informational or advertising campaigns. These campaigns are conducted electronically, and are typically in the form of electronic mail or e-mail.

In a first phase, probabilities, for example, conditional probabilities, of one informational campaign, typically an advertising campaign, with respect to another informational, typically an advertising campaign, are calculated, and values of expected revenue for each campaign are determined from the probabilities. The campaigns with the greatest expected revenues are then analyzed, to determine the extent of their correlation, in the second phase. By having two phases, false positives are nearly eliminated, and only the most relevant advertising campaigns are ultimately evaluated. This provides advertisers with a highly targeted audience, for whom to send their advertising communications, typically in the form of electronic mail (e-mail).

In the second phase, the correlation between two campaigns is determined, by determining a correlation value, indicative of the correlation between two campaigns. This phase involves determining a correlation coefficient between two campaigns, and analyzing the correlation coefficient for a lower confidence limit (LCL), expressed as a value, of a confidence interval. The value of the LCL is used in determining if another informational campaign will be sent to the users who responded to a previous informational campaign.

In the additional third phase, the actual campaign to be delivered to each user (recipient) is based on that user's (recipient's) interest. In this phase, a user (recipient) interest score for each campaign is determined. This user (recipient) interest score is based on the user's (recipient's) historical behavior, and as such, allows for the best campaign suitable for that particular user (recipient) to be delivered to him.

An embodiment of the disclosed subject matter is directed to a method for determining the correlation between information to be distributed to recipients. The method includes, sending a first electronic communication, for example, an electronic mail (e-mail), corresponding to first information (for example, a first advertising campaign) to a plurality of recipients. The first electronic communication is designed to be responded to. A second electronic communication, for example, an electronic mail (e-mail), corresponding to second information (for example, a second advertising campaign) is sent to at least substantially all of the plurality of recipients of the first electronic communication, the second electronic communication is also designed for being responded to. Responses are received to the first electronic communication and the second electronic communication, and the received responses to the first electronic communication and the second electronic communication from the plurality of recipients, and non-responses to the first electronic communication and the second electronic communication from the plurality of recipients, are tabulated. Based on the tabulation, a correlation or probability value between the first information and the second information is determined. This correlation value is indicative in determining if other information will be sent to recipients or users who received (and responded to) previous information.

Another embodiment of the invention is directed to a method for distributing informational campaigns, such as advertising campaigns. The method includes, sending a plurality of recipients e-mails for a first informational campaign and a second informational campaign, the e-mails subject to responses from users, from a non-responded to status, to an opened status, to an activated status, where the recipient has opened the e-mail and the browser associated with the recipient has been directed to a target web site associated with the opened e-mail. The e-mails are monitored for their status, and values are assigned to the e-mails for the first informational campaign and the second informational campaign, in accordance with the monitored status of the e-mails. A correlation value between the first informational campaign and the second informational campaign is determined based on values assigned to the e-mails for the first and second informational campaigns. This correlation value is indicative in determining if another informational campaign will be sent to recipients or users who received (and responded to) a previous informational campaign.

Another embodiment of the disclosed subject matter is directed to a method for distributing informational campaigns. The method includes, providing a plurality of informational campaigns and determining the expected revenue for each campaign. For each campaign having an expected revenue above a predetermined monetary value, first and second informational campaigns, for example, advertising campaigns, are designated. Plural recipients are sent e-mails for the first informational campaign and the second informational campaign. The e-mails are subject to responses from recipients (users), from a non-responded to status, to an opened status, to an activated status, where the recipient has opened the e-mail and the browser associated with the recipient has been directed to a target web site associated with the opened e-mail. The e-mails are then monitored for their status, and values are assigned to the e-mails for the first informational campaign and the second informational campaign, in accordance with the monitored status of the e-mails. A correlation value between the first informational campaign and the second informational campaign is determined, based on values assigned to the e-mails for the first and second informational campaigns. This correlation value is indicative in determining if another informational campaign will be sent to recipients or users who received (and responded to) a previous informational campaign.

Another embodiment of the disclosed subject matter is directed to a system for determining the correlation between informational campaigns, for example, advertising campaigns, to be sent to recipients. The system includes, but is not limited to, four components. There is a first component configured for sending a first electronic communication corresponding to a first informational campaign to a plurality of recipients, the first electronic communication being configured for being responded thereto, and for sending a second electronic communication corresponding to a second informational campaign to at least substantially all of the plurality of recipients of the first electronic communication, the second electronic communication being configured for being responded thereto. The first and second electronic communications are, for example, e-mails. There is a second component for receiving responses to the first electronic communication and the second electronic communication from the first component. A third component serves to tabulate the received responses to the first electronic communication and the second electronic communication from the plurality of recipients, and non-responses to the first electronic communication and the second electronic communication from the plurality of recipients, from the second component. There is a fourth component for determining a correlation value between the first informational campaign and the second informational campaign, based on the tabulated responses and non-responses, from the third component. This correlation value is indicative in determining if another informational campaign will be sent to recipients or users who received (and responded to) a previous informational campaign.

Another embodiment of the disclosed subject matter is directed to a computer-usable storage medium. The storage medium has a computer program embodied thereon for causing a suitably programmed system to determine the correlation between two informational campaigns, for example, advertising campaigns, by performing the following steps when such program is executed on the system. The steps include, sending a first electronic communication corresponding to a first informational campaign to a plurality of recipients, the first electronic communication being configured for being responded thereto, and sending a second electronic communication corresponding to a second informational campaign to at least substantially all of the plurality of recipients of the first electronic communication, the second electronic communication being configured for being responded thereto. The first and second electronic communications are, for example, electronic mail or e-mail. The next step includes, receiving responses to the first electronic communication and the second electronic communication, followed by tabulating the received responses to the first electronic communication and the second electronic communication from the plurality of recipients, and non-responses to the first electronic communication and the second electronic communication from the plurality of recipients, and, determining a correlation value between the first informational campaign and the second informational campaign, based on the tabulated responses and non-responses. This correlation value is indicative in determining if another informational campaign will be sent to recipients or users who received (and responded to) a previous informational campaign.

Another embodiment is directed to a method for determining at least one informational campaign, for example, an advertising campaign, for a recipient (user). The method includes determining the conditional probability between a target campaign and a predictor campaign pair, for a plurality of target campaigns and a plurality of predictor campaigns; determining the expected value of each campaign pair; determining a correlation value for each campaign pair; and, determining a user interest score for each predictor campaign of the predictor campaigns in the existing campaign pairs. The determination of the expected value of each campaign pair is determined as, as a function of: the conditional probability; and, a first predetermined value, for example, a pay per click value, for the target campaign.

Another embodiment is directed to a system for determining at least one informational campaign, for example, an advertising campaign, for a recipient (user). The system includes a storage device and a processor. The processor is programmed to:maintain in the storage device a database a list of a plurality of target campaigns and a plurality of predictor campaigns; determine the conditional probability between a target campaign and a predictor campaign pair, for the plurality of target campaigns and the plurality of predictor campaigns; determine the expected value of each campaign pair as a function of the conditional probability, and a first predetermined value (for example, a pay per click value) for the target campaign; determine a correlation value for each campaign pair; and, determine a user interest score for each predictor campaign of the predictor campaigns in the existing campaign pairs. The system may be on a single server or multiple servers.

Another embodiment is directed to a computer-usable storage medium having a computer program embodied thereon for causing a suitably programmed system to determine at least one informational campaign, for example, an advertising campaign, for a recipient (user), by performing the following steps when such program is executed on the system. The steps include, determining the conditional probability between a target campaign and a predictor campaign pair, for a plurality of target campaigns and a plurality of predictor campaigns; determining the expected value of each campaign pair as a function of, the conditional probability, and, a first predetermined value for the target campaign; determining a correlation value for each campaign pair; and, determining a user interest score for each predictor campaign of the predictor campaigns in the existing campaign pairs.

### BRIEF DESCRIPTION OF THE DRAWINGS

Attention is now directed to the drawings, where like reference numerals or characters indicate corresponding or like components. In the drawings:

FIG. 1 is a diagram of an exemplary system on which embodiments of the invention are performed;

FIG. 2A is a screen shot showing electronic mail (e-mail) communications in the mailbox of a recipient in accordance with the disclosed subject matter;

FIG. 2B is the screen shot of FIG. 2A when a user has decided to open one of the e-mail communications in the mailbox;

FIGS. 3A and 3B are screen shots of the text of e-mails received in accordance with the disclosed subject matter;

FIG. 4 is a screen shot showing a web page accessed from a redirect uniform resource locator in accordance with the disclosed subject matter;

FIG. 5A is a diagram used in determining the probability of predictor advertising campaigns and target advertising campaigns in accordance with the disclosed subject matter;

FIG. 5B shows an application of the diagram of FIG. 5A;

FIG. 6 is an example chart of probabilities for predictor and target campaigns;

FIG. 7A is a diagram used in determining the campaigns that will be subjected to the correlation phase of the disclosed subject matter;

FIG. 7B is the diagram of FIG. 7A, showing an exemplary operation of the disclosed subject matter;

FIG. 8 is a diagram of exemplary responses to various campaigns used to perform a second phase in accordance with the disclosed subject matter;

FIG. 9 is a matrix of the diagram of FIG. 8 as used in determining the correlation coefficients of two campaigns in accordance with the disclosed subject matter;

FIG. 10A is a diagram used in determining the campaigns that will be subjected to the interest score phase of the disclosed subject matter;

FIG. 10B is the diagram of FIG. 10A, showing the result of an exemplary operation;

FIG. 11 is a diagram of exemplary responses to various campaigns used to perform the third phase of the disclosed subject matter;

FIG. 12 is a matrix of the diagram of FIG. 11 as used in determining the correlation coefficients of two campaigns in accordance with the third phase of the disclosed subject matter;

FIG. 13A is a diagram showing the obtained r′ value in accordance with the third phase of the disclosed subject matter;

FIG. 13B is a diagram showing eliminated campaign pairs based on the values of FIG. 13A, in accordance with the third phase of the disclosed subject matter;

FIG. 14 is a table of responses to various campaigns based on the daily behavior of the user, whose responses are being analyzed in accordance with the third phase of the disclosed subject matter;

FIG. 15 is a table of interest scores based on the table of FIG. 14;

FIG. 16A is a table listing value of Interest Scores by the user for each campaign pair; and

FIG. 16B is a table ranking campaign pairs based on the values from the Table of FIG. 16A.

This document also includes a Large Table Appendix on a Compact Disk (disclosed above) as Appendix A, and Appendix B, that is attached to this document.

### DETAILED DESCRIPTION OF THE DRAWINGS

The present invention is related to systems and methods for behavioral targeting of users along a network such as the Internet, for various informational campaigns, such as advertising campaigns. The invention typically involves a two or three phase process.

In a first phase, probabilities of one informational campaign, typically an advertising campaign, with respect to another informational, typically an advertising campaign, are calculated, and values of expected revenue for each campaign are determined from the probabilities. The campaigns with the greatest expected revenues are then analyzed, to determine the extent of their correlation, in the second phase. By performing the process in two phases, false positives are nearly eliminated, and only the most relevant advertising campaigns are ultimately evaluated. This provides advertisers with a highly targeted audience, for whom to send their advertising communications, typically in the form of electronic mail (e-mail).

In the second phase, the correlation between two campaigns is determined. The correlation is expressed as a value. This phase involves determining a correlation coefficient between two campaigns, and analyzing the correlation coefficient for a lower confidence limit (LCL), expressed as a value, of a confidence interval.

The value of the correlation coefficient is used in determining if another informational campaign will be sent to the users, who received a previous informational campaign. The value of the correlation coefficient is in a range of −1 to 1. For example, the preferred values for the correlation coefficient are those as close as possible to 1.

From the correlation coefficient, a lower confidence limit (LCL) is calculated. The largest LCL (value for the LCL) is typically indicative of the campaigns considered to be the most correlated. Similarly, smaller LCLs or LCL values, are considered to have less correlated campaigns. When multiple paired campaigns are evaluated, the LCLs (LCL values) can be ranked, from largest to smallest, with the ranking indicative of the most correlated campaigns. Accordingly, the more correlated campaigns (high LCL) are typically sent to recipients (users) before the less correlated campaigns (low or lower LCL).

In an additional or third phase, the actual campaign to be delivered to each user is based on that user's interest. In this phase, a user interest score for each campaign is determined. This user interest score is based on the user's historical behavior, and as such, allows for the best campaign suitable for that particular user to be delivered to him.

Throughout this document, numerous textual and graphical references are made to trademarks. These trademarks are the property of their respective owners, and are referenced only for explanation purposes herein.

Also throughout this document, references are made to “n” and “nth”, to indicate the last member, component, element, etc., of a series, sequence or the like.

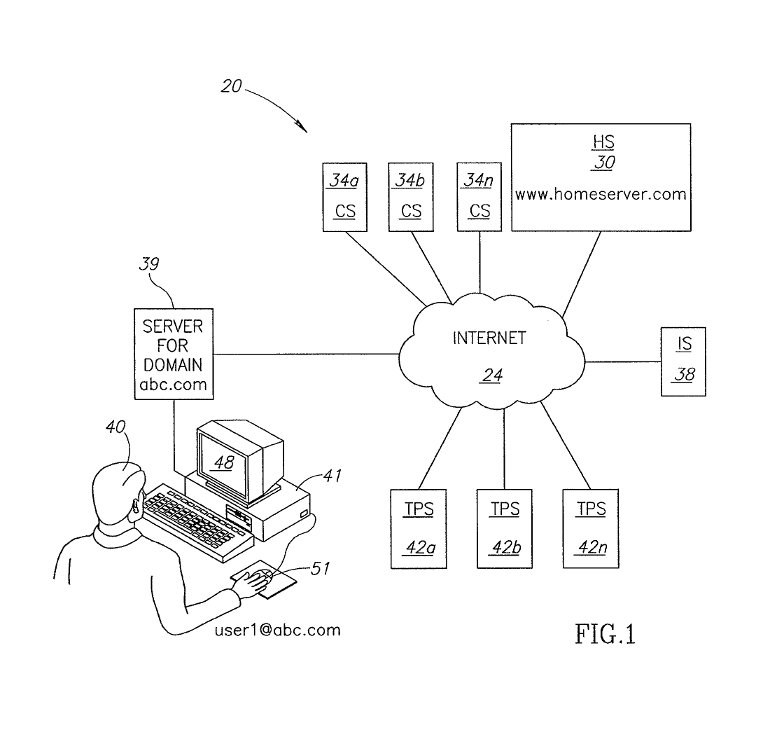

FIG. 1 shows the present disclosed subject matter in an exemplary operation. The present disclosed subject matter employs a system 20, formed of various servers and server components, that are linked to a network, such as a wide area network (WAN), that may be, for example, the Internet 24.

There are, for example, numerous servers that are linked to the Internet 24, as part of the system 20. These servers typically include a Home Server (HS) 30, one or more content servers (CS) 34a-34n, as well as numerous other servers and devices. Depending on the content to be provided to users (in particular, to their computers or other computer-type devices or machines, through their e-mail clients) there may also be imaging servers, such Imaging Server (IS) 38, that along with the servers and related components described herein, are detailed in commonly owned U.S. patent application Ser. No. 10/915,975, entitled: Method And System For Dynamically Generating Electronic Communications (U.S. Patent Application Publication No. 2005/0038861 A1), this patent application and Patent Application Publication, are incorporated by reference herein. U.S. patent application Ser. No. 10/915,975, entitled: Method And System For Dynamically Generating Electronic Communications and U.S. Patent Application Publication No. 2005/0038861 A1, are used interchangeably herein. All of the aforementioned servers are linked to the Internet 24, so as to be in communication with each other. The servers 30, 34a-34 and 38 (depending on the content being sent to users), include multiple components for performing the requisite functions as detailed below, and the components may be based in hardware, software, or combinations thereof. The aforementioned servers may also have internal storage media and/or be associated with external storage media.

The servers 30, 34a-34n, 38 of the system 20 are linked (either directly or indirectly) to an endless number of other servers and the like, via the Internet 24. Other servers, exemplary for describing the operation of the system 20, include a domain server 39 for the domain (for example, the domain “abc.com”) of the user 40 (for example, whose e-mail address is user1 abc.com), linked to the computer 41 (or other computer type device) of the user. Still other servers may include third party servers (TPS) 42a-42n, controlled by content providers and the like.

While various servers have been listed, this is exemplary only, as the present invention can be performed on an endless numbers of servers and associated components, that are in some way linked to a network, such as the Internet 24. Additionally, all of the aforementioned servers include components for accommodating various server functions, in hardware, software, or combinations thereof, and typically include storage media, either therein or associated therewith. Also in this document, the aforementioned servers, storage media, components can be linked to each other or to a network, such as the Internet 24, either directly or indirectly.

The home server (HS) 30 is of an architecture that includes storage devices and components, components for handling electronic mail, to perform an electronic mail (e-mail) server functionality, including e-mail applications. The home server (HS) 30 also includes components for recording events, such as the status of e-mails, when e-mails are sent, whether or not there has been a response to an e-mail (a certain time after the e-mail has been sent), whether the e-mail has been opened, and whether the opened e-mail has been activated or “clicked”, such that the browser of the user is ultimately directed to target web site, corresponding to the link that was “clicked.”

The architecture also includes components for providing numerous additional server functions and operations, for example, comparison and matching functions, policy and/or rules processing, various search and other operational engines. The home server (HS) 30 includes various processors, including microprocessors, for performing the aforementioned server functions and operations. The home server (HS) 30 may be associated with additional caches and databases, such as those as well as numerous other additional storage media, both internal and external thereto. The home server (HS) 30 and all components associated therewith are, for example, in accordance with the home server (HS) 30, described in U.S. Patent Application Publication No. 2005/0038861 A1.

The home server (HS) 30 composes and sends e-mails to intended recipients (for example, e-mail clients hosted by a computer, workstation or other computing device, etc., associated with a user), over the network, typically a wide area network (WAN), such as the Internet 24, and sends these e-mails to e-mail clients in computers associated with users. The e-mail clients may be, for example, America Online® (AOL®), Outlook®, Eudora®, or other web-based clients. In this document, the client is an application that runs on a computer, workstation or the like and relies on a server to perform some operations, such as sending and receiving e-mail. Also, for explanation purposes, the Home Server (HS) 30 may have a uniform resource locator (URL) of, for example, www.homeserver.com.

The e-mails, sent by the home server (HS) 30, may be e-mails in accordance with those sent by the home server (HS) 30 in commonly owned U.S. Patent Application Publication No. 2005/0038861 A1. The e-mail may also be “static” e-mails, where the content and underlying links to target web sites are fixed when the e-mail is sent.

For example, the intended recipient or user 40 has a computer 41 (such as a multimedia personal computer with a Pentium® CPU, that employs a Windows® operating system), that uses an e-mail client. The computer 41 is linked to the Internet 24.

Content Servers (CS) 34a-34n (one or more) are also linked to the Internet 24. The content servers (CS) 34a-34n provide content, typically in text form, for the imaging server (IS) 38, typically through the Home Server (HS) 30, and typically, in response to a request from the Home Server (HS) 30, based on a designated keyword. These content servers (CS) 34a-34n may be, for example, Pay-Per-Click (PPC) servers of various content providers, such as internal providers, or external providers, for example, Overture Services, Inc. or Findwhat, Inc.

At least one imaging server (IS) 38 is linked to the Internet 24. The imaging server (IS) 38 functions to convert text (data in text format) from the content servers (CS) 34a-34n, as received through the Home Server (HS) 30, to an image (data in an image format). After conversion into an image, the image is typically sent back to the home server (HS) 30, to be placed into an e-mail opened by the user 40, as detailed below. Alternately, the imaging server (IS) 38 may send the image directly to the e-mail client associated with the user 40, over the Internet 24.

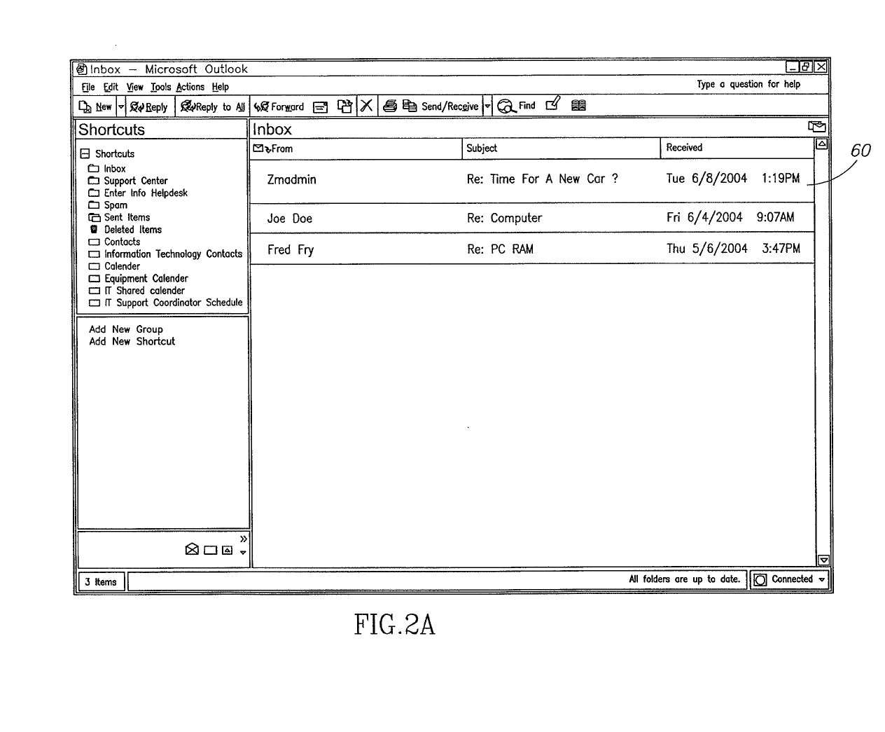

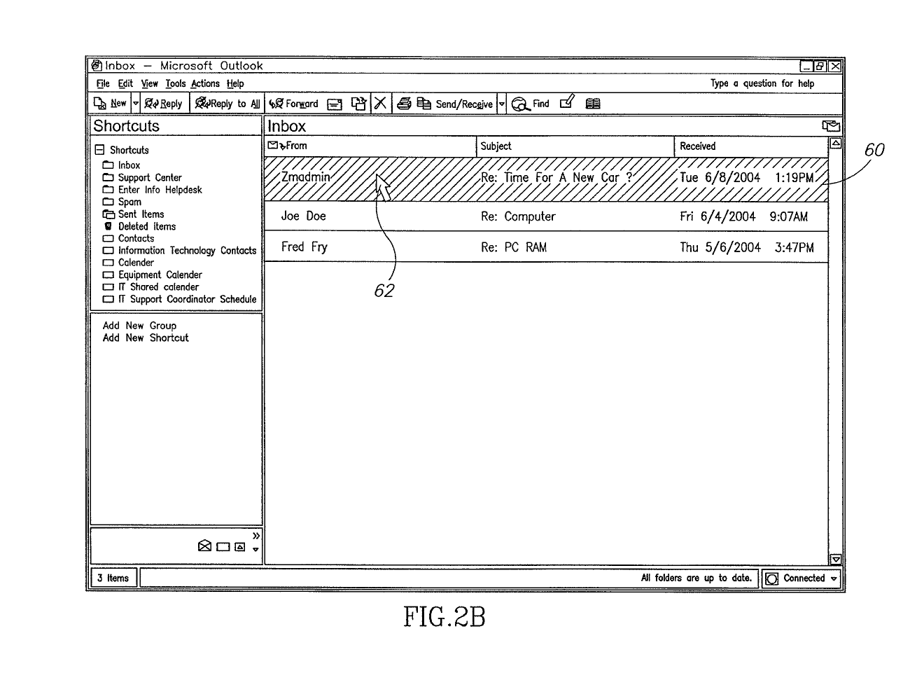

Turning also to FIG. 2A, an e-mail is sent to the e-mail client associated with the computer 41 of the user 40, typically from the Home Server (HS) 30. This e-mail appears in the mailbox of a user, in the form of a line of text 60, identifying the sender, subject and other information. This e-mail 60 is in addition to the other e-mails received in the mailbox 61a, 61b. Once a reference to the e-mail being in a user's mailbox appears as the line of text 60 in the user's mail box, the e-mail is considered to have been “sent” (and is referred to as a “sent e-mail”).

The “sent e-mail” as represented by text line 60, may be, for example, in Hypertext Markup Language (HTML), and may include one or more Hypertext Transport Protocol (HTTP) source requests. These HTTP source requests typically reference the Home Server (HS) 30.

The e-mails sent by the home server (HS) 30, may be in accordance with the e-mails of U.S. Patent Application Publication No. 2005/0038861 A1. It may also be in accordance with the conventional or static e-mail. The text line 60 corresponding to the e-mail sought to be opened, is then opened by activating a mouse or other pointing device, commonly known as “clicking” on the e-mail (the line of text 60 corresponding to the e-mail). The activation or click is indicated by the arrow 62, as shown in FIG. 2B.

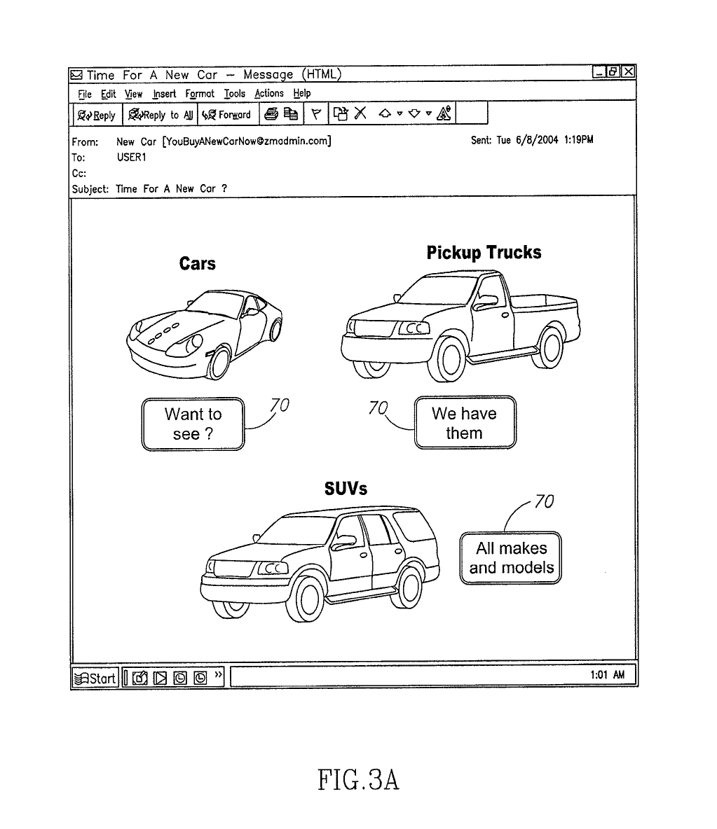

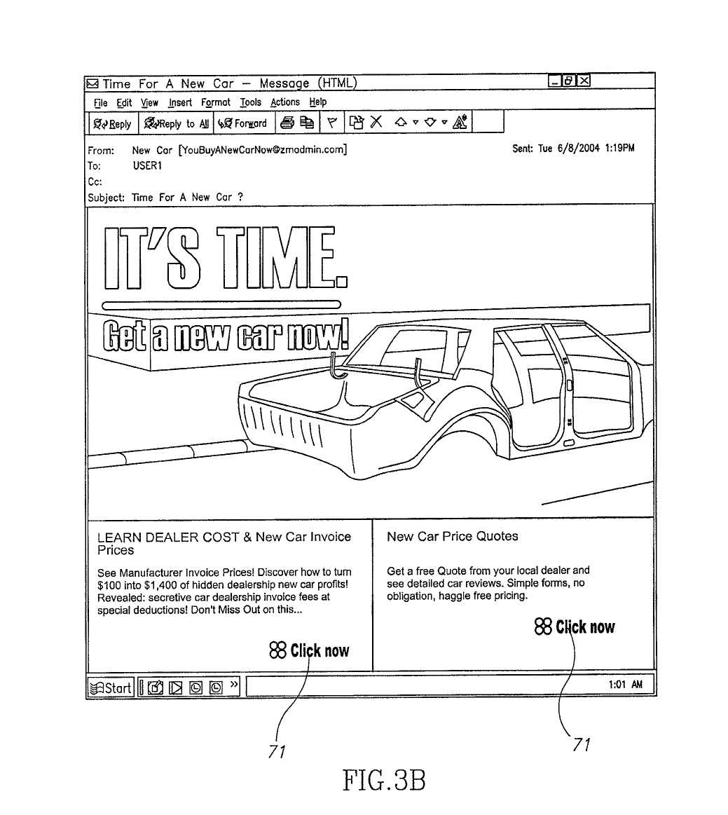

With the e-mail now being opened, templates are built out, resulting in one of the two screen shots of the opened e-mail, as shown in FIGS. 3A and 3B, depending on the type of template and method in which the content of the template is generated. FIG. 3A shows screen shot of a static e-mail, and FIG. 3B shows a screen shot of a dynamic e-mail in accordance with the e-mails disclosed in U.S. Patent Application Publication No. 2005/0038861 A1. With the screen shots of FIGS. 3A or 3B having been activated or accessed, and appearing on the monitor or other viewing device associated with the user's e-mail client, the e-mail is considered to be “opened”. This opening of the e-mail is recorded in the home server (HS) 30.

Both opened e-mails include buttons, locations or the like, on the image that covers the links 70 (FIG. 3A), 71 (FIG. 3B). These links 70, 71, when activated by the mouse or other pointing device or “clicked” on, will direct the browser (web browsing application) to the home server (HS) 30, and then, the browser is redirected to a targeted web site. By clicking on the respective links 70, 71, the e-mail is considered to be “clicked”, and the “click” is recorded in the home server (HS) 30.

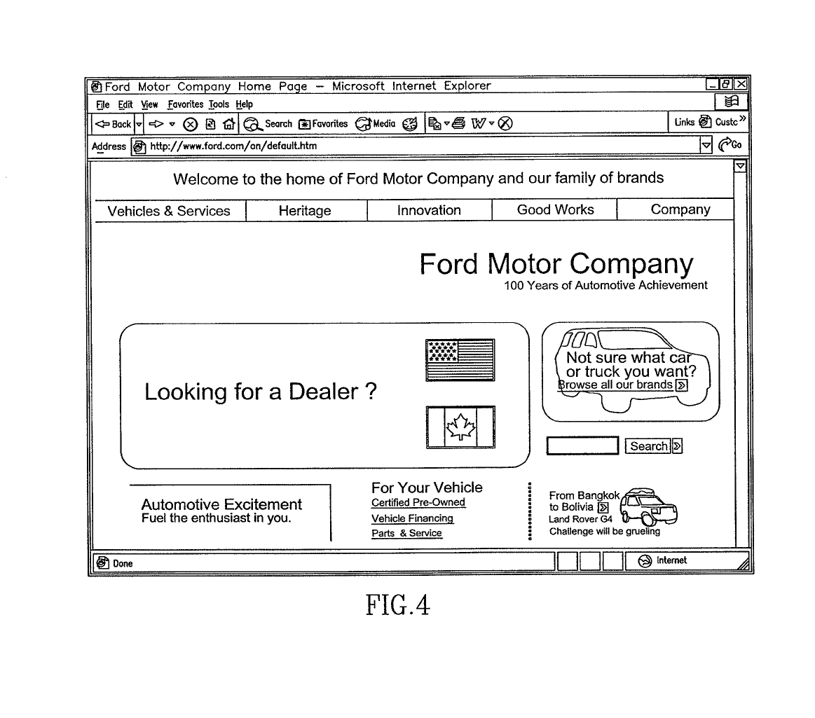

The targeted web site associated with the link is shown, for example, as the screen shot of FIG. 4, and may be hosted, for example on any one of the third party servers (TPS) 42a-42n. Exemplary processes associated with directing the browser of the user to the targeted web site upon clicking on the respective links 70, 71 are detailed in U.S. Patent Application Publication No. 2005/0038861 A1.

While FIGS. 2A, 2B, 3A and 3B show processes associated with a single e-mail, the e-mails, as detailed herein, are typically sent in batches to tens of thousands of users (the e-mail clients associated therewith). These batches of e-mails typically are informational campaigns, and for example, are advertising campaigns, that advertisers (web site promoters) use to being potential customers to their web sites (or web pages), or other targeted web sites (or web pages).

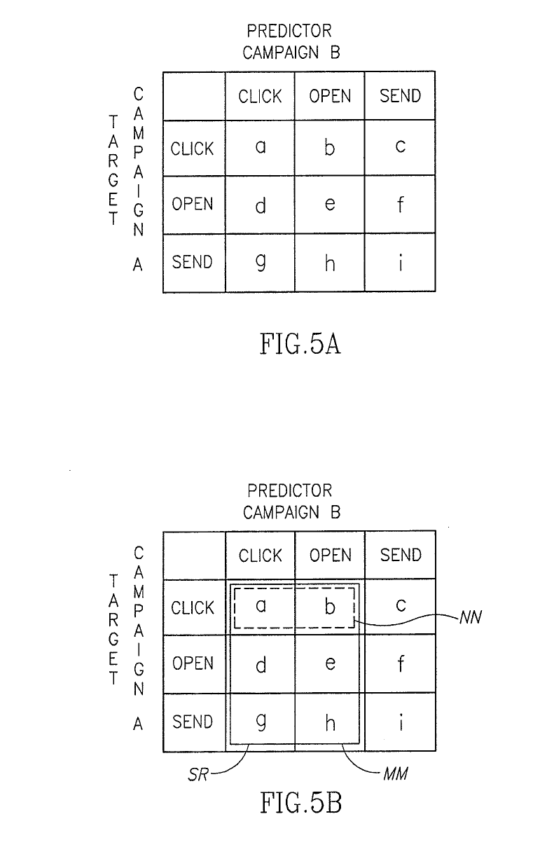

Attention is now directed to FIGS. 5A and 5B, where a process for behavioral targeting users, associated with computers, nodes or the like along the network, is described. The process involves two phases.

In a first phase, probabilities of one informational campaign, typically, an advertising campaign, with respect to another campaign (informational, for example, advertising), are calculated, and values of expected revenue for each campaign are determined from the probabilities. The campaigns with the greatest expected revenues are then analyzed, to determine the extent of their correlation, in the second phase. By performing the process in two phases, false positives are nearly eliminated, and only the most relevant advertising campaigns are ultimately evaluated. This provides advertisers with a highly targeted audience, for whom to send their advertising communications, typically in the form of electronic mail.

To determine the probability of one advertising campaign, with respect to another, and the expected revenue for the respective campaigns, there will be, for example, five advertising campaigns established. These campaigns include: Campaign A, a campaign for Automobiles; Campaign B, a campaign for boats; Campaign C, a campaign for carpet; Campaign D, a campaign for dog toys; and, Campaign E, a campaign for eggs. These campaigns are also referred to throughout this document by their shortened names, A, B, C, D and E. Every campaign is evaluated with respect to every other campaign. For example, P(A | B) represents the probability that a user will respond to a communication, typically, an e-mail, for Campaign A, given that the user has responded to Campaign B in the past. By “responded”, it is meant, that the a user has either “opened”, or, “opened” and “clicked”, collectively “clicked”, the e-mail sent to him. Also, an e-mail is considered “sent” when it was sent but not responded to in a predetermined time period after its having been sent.

In looking at P(A | B) (the probability that a user will respond to a communication, typically, an e-mail, for Campaign A, given that the user has responded to Campaign B in the past), Campaign A is the “target” campaign, while Campaign B is the “predictor” campaign, as shown in FIG. 5A. For example, the probability of P(A | B) is determined in accordance with the diagram of FIG. 5B.

In FIG. 5A, the predictor campaign, Campaign B, and moving horizontally, right to left, are columns for the e-mail for Campaign B, being “sent”, “opened”, and “clicked”, as detailed and defined above. For the Target Campaign, here, Campaign A, and moving vertically, bottom to top, are rows for the e-mail for Campaign A, being “sent”, “opened”, and “clicked”, as detailed and defined above. The columns and rows are combined to form nine spaces, in which a letter a-i has been entered. For example, the space that “a” occupies, corresponds to the number of user's who have “clicked” on e-mails for both Campaign B and Campaign A. While any amount of users is permissible, the diagrams of FIGS. 5A and 5B are typically built based on at least approximately 1000 users being sent e-mails for the Predictor and Target campaigns.

In FIG. 5B, the probability that a user will respond to Campaign A, given that the user has responded to Campaign B in the past, expressed as “P(A | B)”, is determined by taking the number of users who have clicked on the Target Campaign (Campaign A) and responded to the Predictor Campaign (Campaign B), illustrated by the broken line block NN and expressed as “a+b”, from the set (SR) of users who responded to the predictor campaign, over the number of users who have responded to the Predictor Campaign (Campaign B), illustrated by the solid line block MM, and expressed as “a+b+d+e+g+h”. In equation form, this probability P(A | B), is expressed as follows:
P(A | B)=NN/MM=(a+b)/(a+b+d+e+g+h)

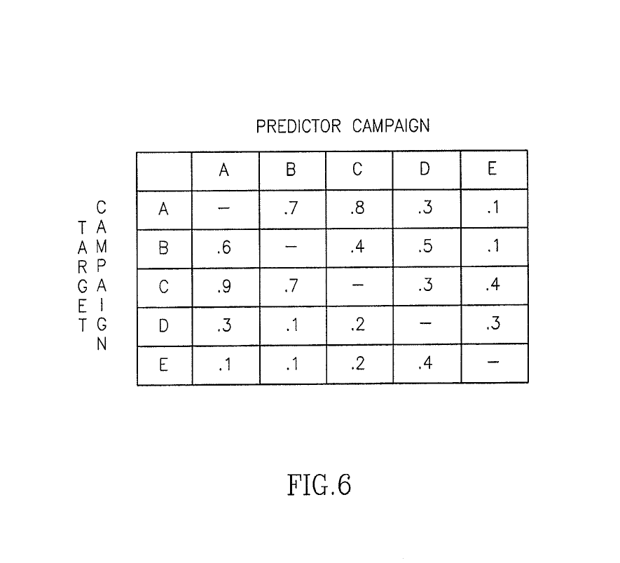

By performing these calculations, the exemplary diagram and result list is obtained in FIG. 6. For example, in this diagram, the probability that a user will respond to Campaign A, given that the user has responded to Campaign B in the past, expressed as “P(A | B)”, is 0.7, while the probability that a user will respond to Campaign B, given that the user has responded to Campaign A in the past, expressed as “P(B | A)” is 0.6.

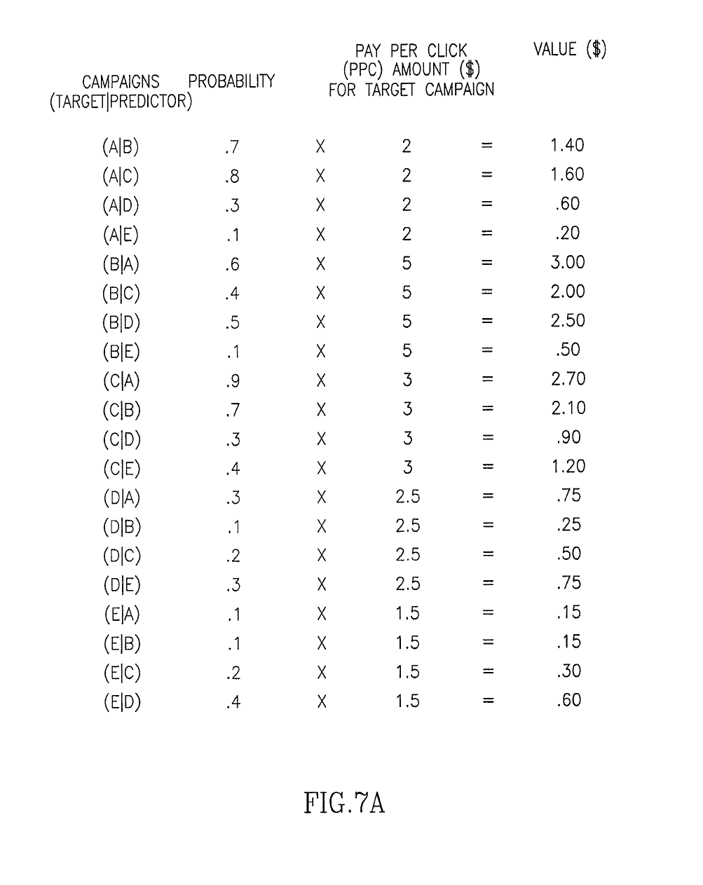

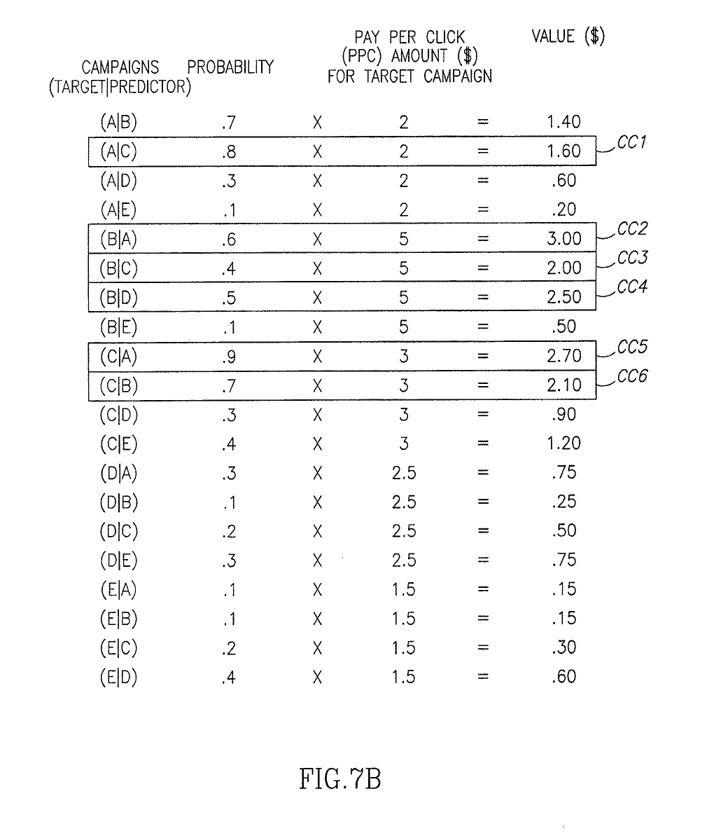

Using the probabilities from FIG. 6, the Table of FIG. 7A is developed. In this Table, there is an amount, typically monetary, that a web site promoter or owner of the target web site, will pay when their web page accessed after a corresponding link is “clicked” by a user. This is known as Pay Per Click (PPC), cost per click, etc. For example, the target web page for Campaign A will pay $2 (PPC amount of $2), Campaign B will pay $5, Campaign C will pay $3, Campaign D will pay $2, and Campaign E will pay $1.50. These monetary amounts, multiplied by the probabilities, will yield a return, as a monetary amount or value (also known as an expected value). It will then be determined the amount of a return or value that is sufficient to move to the second phase of the process, determining the correlation coefficient.

For example, it has been determined that returns of $1.50 or more are sufficient for determining the correlation coefficient. Accordingly, only target campaigns A, B and C, include return amounts of at least $1.50, as indicated by the boxes CC1-CC6 of FIG. 7B (the table of FIG. 7A including the boxes CC1-CC6). It is these three campaigns, A, B and C, represented by campaign pairs (A | C), (B | A), (B | C), (B | D), (C | A), (C | B), that will be subjected to the second phase, the analysis for the correlation component of these campaigns, as detailed below.

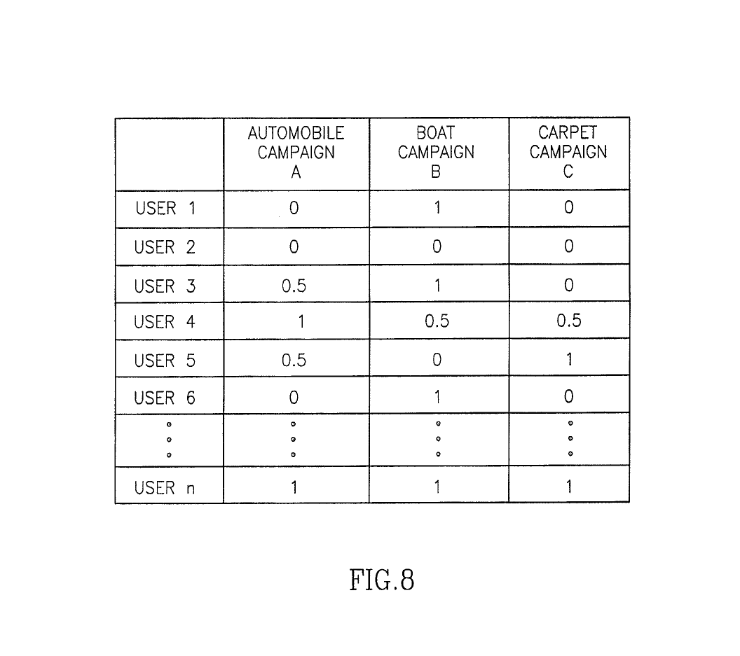

Attention is now also directed to FIG. 8, a diagram illustrating a sampling of results from approximately 1000 users (1000 being sufficient to establish a random sampling), USER 1 to USER n (n is the last user in a series of users), in accordance with an embodiment of the invention. For example, assume that all of the users, USER 1 to USER n, have received the three advertising campaigns, A, B and C, based on the results of the first phase of the process, detailed above. The advertising campaigns (A, B and C) are e-mail based in accordance with the e-mails detailed above, and, for example, all of the users were sent an Automobile Campaign (Campaign A), a boat campaign (Campaign B) and a Carpet Campaign (Campaign C). For example, the automobile campaign (Campaign A) is exemplary of Campaigns B and C, and is represented by the screen shots of FIGS. 2A, 2B, 3A, 3B and 4.

The advertising campaigns are, for example, sent from the home server (HS) 30, and are received by the intended recipients, for example, USER 1 to USER n, in accordance with the dynamic or static e-mail described herein. For example, the sent e-mails may be opened, by the user clicking on the text bar, with this opening resulting in the screen shots of FIGS. 3A or 3B, providing for links (that as detailed above, if “clicked” will redirect the browser of the user to a targeted web site). This opening event is recorded by the home server (HS) 30 as an “opening.” The links may then be clicked, with the browser of the user ultimately being directed to the target web site. This clicking event is recorded in the home server (HS) 30 as a “redirect.” Should the user not respond to the e-mail in a predetermined time after it was sent by the home server (HS) 30, this even indicating the lack of response in a predetermined time is recorded in the home server (HS) 30 as a “non-response.”

Staying in FIG. 8, the aforementioned responses from the users, USER 1 to USER n, are provided with values. An “opening” of the e-mail is provided with a value of 0.5, a “click” (open with a click) of the e-mail is provided with the value 1, while a “non-response” is provided a value of 0. For example, USER 3 opened the Automobile Campaign (Campaign A), for a value of 0.5, opened the e-mail and “clicked” on the link therein to be redirected to the targeted web site for the Boat Campaign (Campaign B), for a value of 1, but did not respond to the e-mail (a “non-response”) of the Carpet Campaign (Campaign C), for a value of 0.

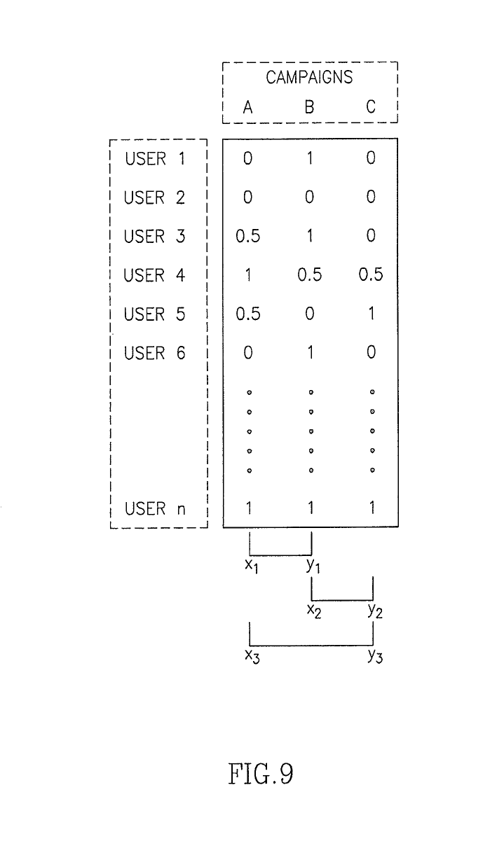

The charted responses of FIG. 8 are now converted into the data matrix of FIG. 9. The headings are shown in broken line boxes for explanation purposes only. This data matrix is an “m by n” matrix, where m represents the number of campaigns, here, for example, Campaigns A-C to be tested, and n represents the number of e-mail users, here, for example, e-mail users (USER 1 to USER n).

The second phase of the process now begins. In this second phase, the correlation between informational or advertising campaigns is determined, as a correlation value is determined for two campaigns. This correlation value provides an indication of the correlation between two campaigns.

Initially, a correlation coefficient will be determined between two campaigns, and each correlation coefficient will be analyzed for a lower confidence limit (LCL), a value that is calculated. This LCL value will be useful in determining which campaigns to send to which users (recipients), and will allow for a ranking of correlated campaigns for sending to users (recipients).

Turning to FIG. 9, correlations between two advertising campaigns are viewed in accordance with correlation vectors, paired as x and y and expressed as (x,y), for example, as (x₁, y₁), (x₂, y₂), (x₃, y₃), as indicated at the matrix. This correlation is represented by the correlation coefficient “r”. The correlation coefficient “r” is also known and referred to herein as a Pearson's Correlation Coefficient. The correlation coefficient “r” is a measure of the correlation among two vectors, x and y. The correlation coefficient is expressed as:
r=cov (x,y)/σ(x)σ(y)

where,
cov (x,y) is a correlation vector of one campaign x to another campaign y;
σ(x) is a vector representative of the responses (opens and opens and clicks) to a first campaign;
σ(y) is a vector representative of the responses (opens and opens and clicks) to a second campaign; and,
n is the number of observations (sample or number of users who have been sent both campaigns).

The relationship of the correlation vector (cov (x,y)) to the vectors σ(x) and σ(y), is expressed in the equation:

$$r = \frac{cov ( x , y )}{σ ( x ) σ ( y )} = \frac{n Σ x y - Σ x Σ y}{[ n Σ {x}^{2} - {( Σ x )}^{2} ] \cdot [ n Σ {y}^{2} - {( Σ y )}^{2} ]}$$

The equation will yield a value of “r”, the correlation coefficient, ranging from −1 to 1. A positive value of the correlation coefficient “r” typically indicates a positive correlation between the two campaigns. Here for example, correlation coefficients “r” are determined for the correlation of Campaign A to Campaign B, the correlation of Campaign B to Campaign C, and, the correlation of Campaign A to Campaign C. Typically, the closer the correlation coefficient (r) is to “1”, the greater the correlation between the two campaigns being analyzed. Also, it is typical that campaigns whose correlation coefficient (r) is negative are not further analyzed.

The accuracy of the Pearson's Correlation Coefficient (r) between the two suitable campaigns, typically having a positive Pearson's Correlation Coefficient (r), is calculated, by applying the Lower Confidence Limit (LCL), expressed as r′, of this value (r). The lower confidence limit (LCL) of the Pearson's Correlation Coefficient (r) is used to rank order the campaigns in order of interest, typically from the highest value to the lowest value. The campaigns associated with the greatest LCL value (r′), are typically delivered first, as these campaigns are the best correlated campaigns, with delivery of the campaigns continuing until all ordered campaigns are exhausted.

The Lower Confidence Limit (LCL) for the Pearson's Correlation Coefficient is calculated, for example, in three steps, using the following method. In the Pearson's correlation coefficient (r), the Lower Confidence Limit (LCL) (r′) is simply the left bound of the confidence interval. The value (r′) for the LCL is typically a value less than 1, and due to the elimination of campaigns with negative correlation coefficients (r), the value for (r′) is typically between 0 and 1.

Step 1

Convert the value of Pearson's correlation coefficient (r) to a confidence interval (z) as:

$$z = 0.5 ln \frac{1 + r}{1 - r}$$

Step 2

Calculate the confidence interval of z, expressed as z′, as:

$${z}^{′} = z \pm \frac{a}{\sqrt{N - 3}}$$

where,
a is a value determined from the table of Cumulative Normal Distribution of Appendix B for the desired LCL, typically, between 90% and 99%, and, for example, 97.5%. Using the Table from Appendix B, this value of “a” is 1.96 for an LCL at 97.5%; and,
N is the sample size (number of users).
   Step 3

Convert the confidence interval of z (expressed as z′) to the LCL value of r′ in accordance with the formula:

$${r}^{′} = \frac{{ⅇ}^{2 {z}^{′}} - 1}{{ⅇ}^{2 {z}^{′}} + 1}$$

The values (r′) for the confidence intervals (z′) for the desired LCLs are ranked, with the greatest LCL (r′) values being the most correlated campaigns.

### EXAMPLE 1

Part 1—Determining The Expected Revenue Of An Advertising Campaign

This Example references the Large Table Appendix (Appendix A) referenced above, and which is incorporated by reference herein. A portion of this Large Table Appendix is Table EX-A.

An Example data set is in the data file, attached to this document on a CD in ASCII language, as Appendix A. In this data set, that forms Table EX-A, there are nine columns representing nine advertising campaigns, from “Art Supplies” to “Vacations.” There are 10,000 rows representing 10,000 users (user01 to user10000). All users were sent all campaigns in e-mails, and have either responded to or not responded to the campaigns. Responses were classified as two kinds, an opening, where the user opened the communication for the campaign, and opened and “clicked.” A user must open an e-mail to click.

A subset of the first ten records of the data set (the Large Table Appendix-Appendix A) for users01-10, is listed in Table EX-A′. In this Table, an e-mail delivery with no response (not opened) is denoted with a value of 0. A delivery with an open but no click is denoted with a value of 0.03, while an e-mail delivery with an open and a click is denoted with a value of 1, such that Table EX-A′ is as follows:

TABLE EX-A′

| | Art | | | | | | | | |
|---|---|---|---|---|---|---|---|---|---|
| | Sup- | | | | Credit | Office | | | Vaca- |
| | plies | Books | Boats | Cars | Cards | Supplies | Shoes | Toys | tions |
| user01 | 0.03 | 0.03 | 0 | 0.03 | 0.03 | 0 | 0 | 0 | 0 |
| user02 | 0.03 | 0.03 | 0.03 | 0 | 0 | 0 | 0 | 0 | 0.03 |
| user03 | 0.03 | 0.03 | 0.03 | 0 | 0 | 0 | 0 | 0 | 0 |
| user04 | 1 | 1 | 0.03 | 0.03 | 0.03 | 0 | 0 | 0 | 0 |
| user05 | 0 | 0 | 0.03 | 0 | 0 | 0 | 0 | 0 | 0 |
| user06 | 0 | 0.03 | 0 | 0.03 | 0.03 | 0 | 0 | 0 | 0 |
| user07 | 0.03 | 0.03 | 0.03 | 0 | 0 | 0 | 0.03 | 0.03 | 0.03 |
| user08 | 0 | 0.03 | 0 | 0.03 | 0.03 | 0.03 | 0 | 0 | 0 |
| user09 | 0 | 0 | 0 | 0 | 0 | 0 | 0 | 0 | 0.03 |
| user10 | 0.03 | 0.03 | 0.03 | 0.03 | 0.03 | 0.03 | 0.03 | 0.03 | 0.03 |

From Table EX-A (and Table EX-A′), user01 responded to the various e-mails for each campaign as follows:
Received, but did not respond to (open, or open and click): Boats, Office Supplies, Shoes, Toys, or the Vacations campaigns (a no response or “0” value);
Received and responded to, by opening, but did not click: Art Supplies, Books, Cars, and Credit Cards campaigns (open but no click or 0.03 value); and
Did not click on any campaigns.

Also from Table EX-A (and Table EX-A′), user04 responded to the various e-mails for each campaign as follows:
Received, but did not respond to (open, or open and click): Office Supplies, Shoes, Toys, or the Vacations campaigns (a no response or “0” value);
Received and responded to, but did not click: Boats, Cars, and Credit Cards campaigns (an open but no click or 0.03 value); and
Responded to by opening and clicking on the Art Supplies and Books campaigns (an open and click or 1 value).

Next, pay per click (PPC) values were provided. A PPC value is the amount of money that will be paid by an advertiser to a search engine or the like for directing a user to the advertiser's target website, when the user clicks on a link to the target web site provided by the search engine. The PPC values for each campaign were provided in List 1, as follows:

TABLE EX-B

| CAMPAIGN | PPC VALUE ($) |
|---|---|
| Art Supplies | $0.32 |
| Books | $1.44 |
| Boats | $1.75 |
| Cars | $0.04 |
| Credit Cards | $0.18 |
| Office Supplies | $0.05 |
| Shoes | $1.40 |
| Toys | $0.15 |
| Vacations | $1.57 |

A conditional probability P_{cond} of a user clicking on one campaign (C1), given they responded to another campaign (C2), also expressed as P(C1 | C2), is given by the following equation:
P_{cond}=P(C1 | C2)=(users that clicked on C1 AND responded to C2)/(Total number of users that responded to C2).

Using the “Art Supplies” and “Books” campaigns, the conditional probability (P_{cond(Artsup-Books)} of a user clicking on the Art Supplies campaign, given that they responded (opened OR opened and clicked) on the Books campaign, also expressed as P(ArtSup | Books), can be given by the following equation:
P_{cond(ArtSup-Books)}=P(ArtSup | Books)=(Number of user users that clicked on the “Art Supply” campaign AND responded to the “ Books” campaign)/(Number of users that responded to the Books campaign).

From the Table (TABLE EX-A) of the Large Table Appendix, the following table, known as Table EX-C, was created, as follows:

TABLE EX-C

| | | | Sent but did not |
|---|---|---|---|
| | Clicked Books | Opened Books | respond to Books |
| Clicked Art | 990 | 255 | 0 |
| Supplies | | | |
| Opened Art | 239 | 2578 | 267 |
| Supplies | | | |
| Sent but did not | 0 | 248 | 5423 |
| respond to Art | | | |
| Supplies | | | |

Using the values from Table EX-C, the conditional probability of a user clicking on the Art Supplies campaign, given that they responded to the “Books” campaign P_{cond(ArtSup-Books)}, also expressed as P(ArtSup | Books), is determined as follows:
P_{cond(ArtSup-Books)}=P(ArtSup | Books)=(990+255)/(990+239+0+255+2578+248=0.2889

A value for expected revenue (ER) is now determined based on the probability of the user clicking on the Art Supply Campaign given they responded to the Books Campaign. This expected revenue (ER) value is determined by the formula:
ER=P_{cond}·PPC

Here, for the specific campaigns of Art Supplies being delivered to users who responded to the “Books” campaign, the expected revenue (ER) is determined in accordance with the formula:
ER=P_{cond(ArtSup-Books)}·PPC_{ArtSupplies}, or
ER=0.2889·$0.32=$0.09

Therefore, the expected revenue (ER) of the Art Supply Campaign as delivered to users who responded to the Books Campaign is $0.09.

Part 2—Adjusting the Expected Revenue Based on Sample Size

An important factor in the calculation of Part 1 that was ignored was the sample size. For Example, suppose there was a pair of campaigns (Campaign A and B) with the Table EX-D, listed as follows:

TABLE EX-D

| | | | Sent but did not |
|---|---|---|---|
| | Clicked B | Opened B | respond to B |
| Clicked A | 1 (ax) | 1 (bx) | 1 (cx) |
| Opened A | 1 (dx) | 1 (ex) | 1 (fx) |
| Sent but did not | 1 (gx) | 1 (hx) | 1 (ix) |
| respond to A | | | |

The probability P(A | B)₁ a user would click on A (ax, bx) given that they responded to B (ax, bx, dx, ex, gx, hx) would be: (1+1)/(1+1+1+1+1+1)= 2/6=0.33.

The same probability would come from the following table:

TABLE EX-E

| | | | Sent but did not |
|---|---|---|---|
| | Clicked B | Opened B | respond to B |
| Clicked A | 1000 (ay) | 1000 (by) | 1000 (cy) |
| Opened A | 1000 (dy) | 1000 (ey) | 1000 (fy) |
| Sent but did not | 1000 (gy) | 1000 (hy) | 1000 (iy) |
| respond to A | | | |

The probability P(A | B)₂ a user would click on A (ay, by) given that they responded to B (ay, by, dy, ey, gy, hy) would be:
(1000+1000)/(1000+1000+1000+1000+1000+1000)= 2000/6000=0.3

The estimate of the probability is the same in the above two cases, but the confidence in the estimate is different. In general, more data yields greater confidence in the estimate.

Part 3—Determining the Confidence in a Sample

One method to quantify a level of certainty in an estimate is to establish a confidence interval (CI). The confidence interval (CI) is the proportion of samples of a given size that may be expected to contain the true mean. For example, in a 90% confidence interval (CI), for the number of samples collected and the confidence interval is computed, over time, 90% of these intervals would contain the true mean.

A 90% Lower Confidence Limit (LCL) is an interval that ranges from a first positive value, upward, to infinity. That is, 90% of the means would fall above the LCL. An important feature of this is that the LCL provides a level of certainty. The less certainty about the estimate, the lower the value must be to ensure that 90% of samples would be above this value. This property is used to account for variances in samples, such as those of Table A. The 90% Lower Confidence Limit (LCL) of the Binomial Distribution is calculated for the sample. This value is substituted for the probability.

Here, the 90% LCL was calculated as follows:
In the examples above the probability P(A | B)₁, P(A | B)₂ was 0.33 for both samples.
The LCL was calculated as follows:
   LCL=P(A | B)−1.645·[(P(A | B))·(1−P(A | B))/6]^{1/2}
whereby, the LCL for the 6 sample test was calculated as:
   LCL₆ₛₐₘₚₗₑₛ=(⅓)−1.645·[(⅓)·(1−⅓)/6]^{1/2}=0.017
while the LCL for the 6000 sample test was calculated as:
   LCL₆₀₀₀ₛₐₘₚₗₑₛ=(⅓)−1.645·[(⅓)·(1−⅓)/6000]^{1/2}=0.323
and, the LCL for Art Supply campaign being delivered to the users who responded to the Books campaign is:
   LCL_{(ArtSup-Books)}=(0.2888631)−1.645·[(0.2888631)·(1−0.2888631)/4310)]^{1/2}=0.2775065.

From List 1 above, the PPC for the Art Supplies Campaign is $0.32. The adjusted expected value is therefore: 0.2775065·$0.32=$0.08.

The above is sufficient to deliver e-mail, as it is above a predetermined threshold, here $0.001.

Part 4A—Analysis of Most Relevant Campaigns, Determining the Correlation Coefficient

In an additional procedure, the campaigns were analyzed to provide users with the most relevant campaigns. Once the non-profitable campaigns were removed, based on the previous procedures, as detailed above, the Pearson's Correlation Coefficient (r) was calculated to determine what campaign the particular user was most interested in, regardless of PPC.

The Pearson's Correlation Coefficient (r) is expressed as follows:

$$r = \frac{Σ X Y - \frac{Σ X Σ Y}{N}}{\sqrt{( Σ {X}^{2} - \frac{{( Σ X )}^{2}}{N} ) ( Σ {Y}^{2} - \frac{{( Σ Y )}^{2}}{N} )}}$$

where, X=responses and non-responses to any first campaign,
Y=responses and non-responses to any second campaign being compared to the first campaign, and,
N=the number of observations (sample size-number of users who have been sent both campaigns).

Taking the data from Table A, the Pearson's Correlation Coefficient (r) between the Art Supplies and Books campaigns is calculated as 0.7812.

The accuracy of the Pearson's Correlation Coefficient (r) between the Art Supplies and Books campaigns is further analyzed, by applying the Lower Confidence Limit (LCL), expressed as r′ (below), of this value (r). The lower confidence limit (LCL) of the Pearson's Correlation Coefficient (r) is used to rank order the campaigns in order of user interest, typically from the highest value to the lowest value. The campaigns associated with the greatest LCL (r′) value, are typically delivered first, as these campaigns are the best correlated campaigns, with delivery of campaigns continuing until all ordered campaigns are exhausted.

The Lower Confidence Limit (LCL) (r′) for the Pearson's Correlation Coefficient (r) was calculated using the following method:

Part 4B—Analysis of Most Relevant Campaigns, Determining the Lower Confidence Limit (LCL) of the Confidence interval

There are three steps to calculate the confidence interval on Pearson's correlation coefficient (r). The Lower Confidence Limit (LCL) (r′) is simply the left bound of the confidence interval.

Step 1

Convert the value of Pearson's correlation coefficient (r) to a confidence interval (z) as:

$$z = 0.5 ln \frac{1 + r}{1 - r} \qquad ( S1 )$$

Step 2

Calculate the confidence interval of z, expressed as z′, as:

$${z}^{′} = z \pm \frac{a}{\sqrt{N - 3}} \qquad ( S2 )$$

where,
a=1.96 for level of confidence or LCL at 97.5%; and
a-2.576 for level of confidence or LCL at 99.5%;
the values for “a” were taken from the table of Appendix B (and determined in accordance with the description in Appendix B), the table entitled:

Cumulative Normal Distribution,
N is the sample size (number of users).
   Step 3

Convert the confidence interval of z (expressed as z′) to the LCL value of r′ in accordance with the formula:

$${r}^{′} = \frac{{ⅇ}^{2 {z}^{′}} - 1}{{ⅇ}^{2 {z}^{′}} + 1} \qquad ( S3 )$$

Part 4C—Applying Steps 1-3 to a 97.5% LCL to Establish a Lower Confidence Level (LCL) Value (r′)

If the correlation coefficient of target campaign and predictor campaign is calculated as r=0.7812 based on 10,000 users. The 97.5% LCL was calculated using formula S1, to obtain a value of z, such that z=1.0484.

A 97.5% lower confidence interval of z, with z=1.0484 (from above), expressed as z′, is LCL (97.5%), using the formula S2, where,

$$\begin{matrix}{z}^{′} = 1.0484 \pm \frac{1.96}{\sqrt{( 1000 - 3 )}} \\ {z}^{′} = 0.9863\end{matrix}$$

whereby, the 97.5% confidence interval of r, expressed as r′, using the formula S3, where z′=0.9863 (from above), is:

$${r}^{′} = \frac{{ⅇ}^{2 {z}^{′}} - 1}{{ⅇ}^{2 {z}^{′}} + 1} = 0.7558$$

In an alternate method, the actual campaign to be delivered to a particular user can be determined based upon user interest. The method is in three phases. In the first phase, conditional probabilities between paired campaigns are determined. The second phase involves determining the correlation coefficient (Pearson's Correlation Coefficient), and then determining the lower confidence level (LCL) to eliminate false positives, to determine the most relevant campaigns. A third phase calculates the user interest score for each campaign, based on the user's historical behavior, in order that the best campaign suited for the particular user be delivered to the user.

This method begins by returning to FIGS. 5A, 5B, and 6, and the accompanying description. This is the aforementioned first phase occurs, where the conditional probabilities between campaign pairs (Target and Predictor Campaigns) are determined.

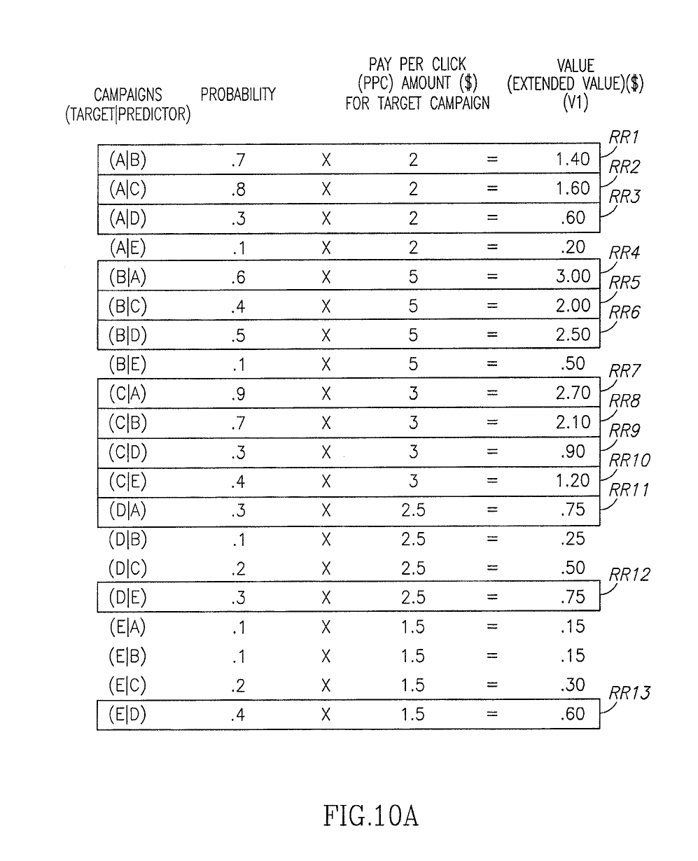

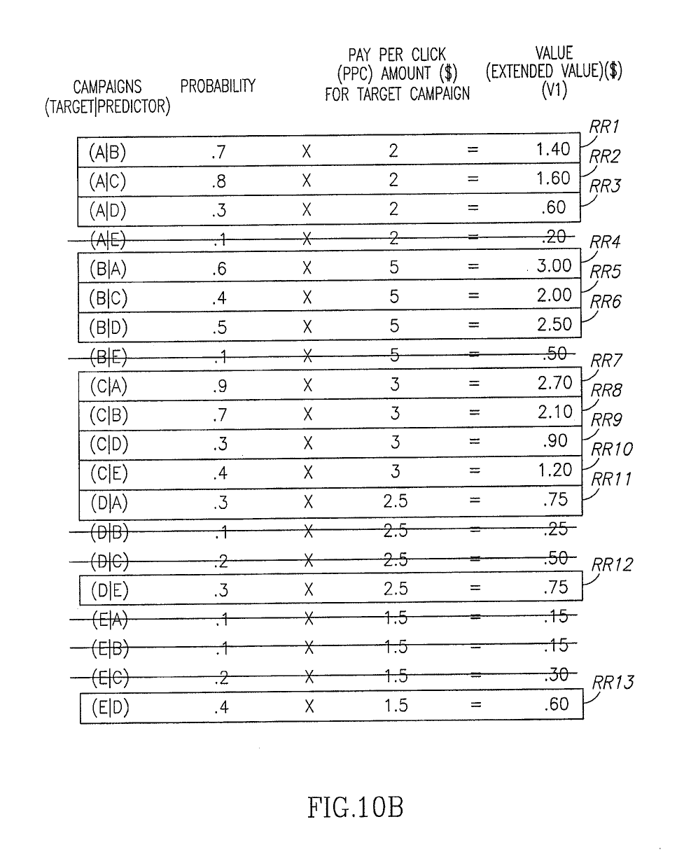

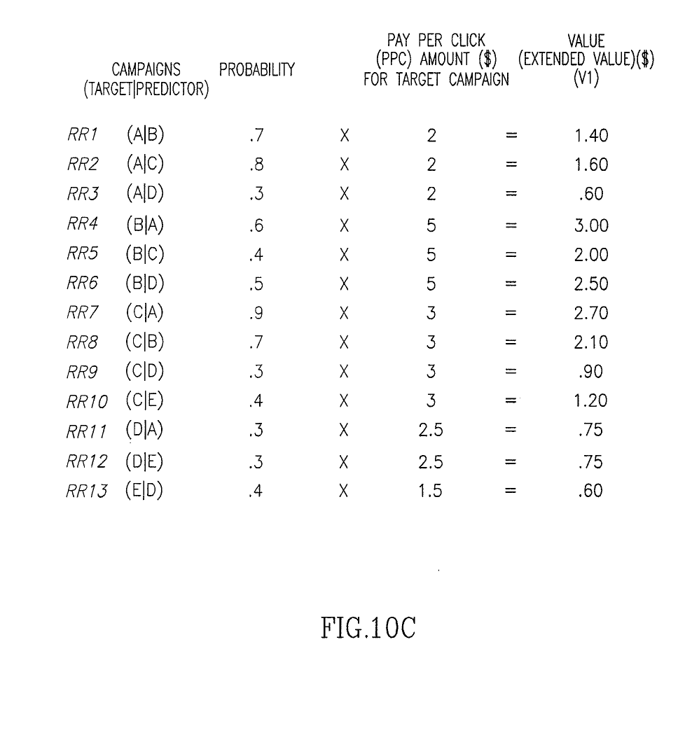

Using the probabilities from FIG. 6, the Table of FIG. 7A is developed, as detailed above. This table is FIG. 10A. Similar to the table of FIG. 7A above, in FIG. 10A, pay per click (PPC) values are such that, target web page for Campaign A will pay $2 (PPC amount of $2), Campaign B will pay $5, Campaign C will pay $3, Campaign D will pay $2, and Campaign E will pay $1.50. These monetary amounts, multiplied by the probabilities, i.e., conditional probabilities, will yield a return, as a monetary amount or value (as referred to in FIGS. 7A and 7B), also known and referred to as an Expected Value (VI) in FIGS. 10A-10C. It will then be determined the amount of a return or value that is sufficient to move to the second phase of the process, determining the correlation coefficient, for example, the Pearson's Correlation Coefficient.

For example, in FIG. 10A, it has been determined that values or Expected Values (VI) of $0.60 or more are sufficient for determining the Pearson's Correlation Coefficient. Accordingly, target campaigns A, B, C, D and E, include return amounts of at least $0.60, as indicated by the boxes RR1-RR13 of FIG. 10A (the Table of FIG. 7A including the boxes RR1-RR13). The Table of FIG. 10A is revised in FIG. 10B, as only the Target-Predictor Campaign pairs of sufficient value (RR1 to RR13) are retained and for the Table of FIG. 10C. It is these campaign pairs: (A | B), (A | C), (A ⊕ D), (B | A), (B | C), (B | D), (C | A), (C | B), (C | D), (C | E), (D | A), (D | E) and (E | D), from the remaining paired Target-Predictor Campaign pairs, that will be subjected to the second phase, the analysis for the correlation coefficient of these campaigns, as detailed below.

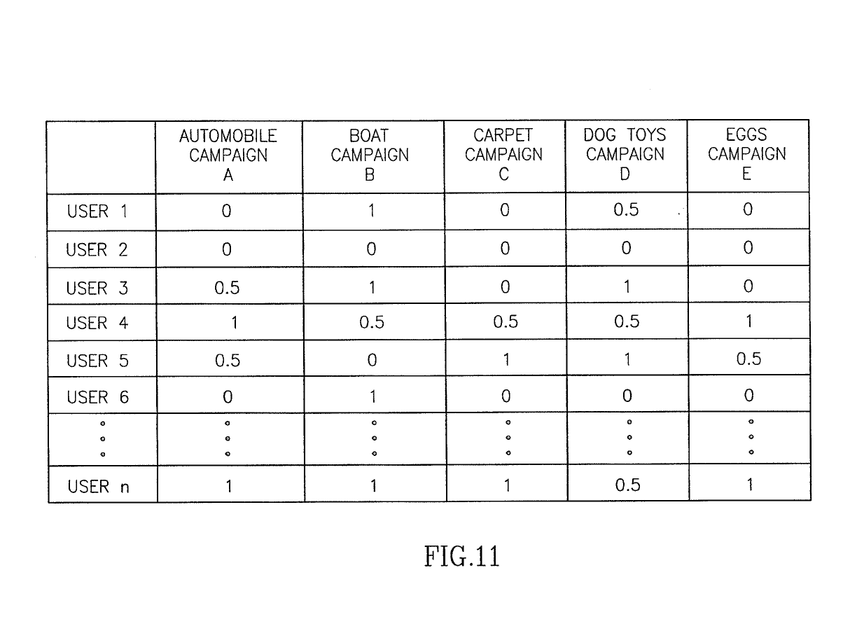

The process moves to a second phase, where the Pearson's correlation coefficient is determined. Attention is now also directed to FIG. 11, a diagram illustrating a sampling of results from approximately 1000 users (1000 being sufficient to establish a random sampling), USER 1 to USER n (n is the last user in a series of users), in accordance with an embodiment of the invention. For example, assume that all of the users, USER 1 to USER n, have received the five advertising campaigns, A, B, C D and E, based on the results of the first phase of the process, detailed above. The advertising campaigns (A, B, C, D and E) are e-mail based in accordance with the e-mails detailed above, and, for example, all of the users were sent an Automobile Campaign (Campaign A), a boat campaign (Campaign B), a Carpet Campaign (Campaign C), a Dog Toys Campaign (Campaign D), and an Eggs Campaign (Campaign E). For example, the automobile campaign (Campaign A) is exemplary of Campaigns B, C, D and E, and is represented by the screen shots of FIGS. 2A, 2B, 3A, 3B and 4.

The advertising campaigns are, for example, sent from the home server (HS) 30, and are received by the intended recipients, for example, USER 1 to USER n, in accordance with the dynamic or static e-mail described herein. For example, the sent e-mails may be opened, by the user clicking on the text bar, with this opening resulting in the screen shots of FIGS. 3A or 3B, providing for links (that as detailed above, if “clicked” will redirect the browser of the user to a targeted web site). This opening event is recorded by the home server (HS) 30 as an “opening.” The links may then be clicked, with the browser of the user ultimately being directed to the target web site. This clicking event is recorded in the home server (HS) 30 as a “click” or “redirect.” Should the user not respond to the e-mail in a predetermined time after it was sent by the home server (HS) 30, this even indicating the lack of response in a predetermined time is recorded in the home server (HS) 30 as a “non-response.”

Staying in FIG. 11, the aforementioned responses from the users, USER 1 to USER n, are provided with values. An “opening” of the e-mail is provided with a value of 0.5, a “click” (open with a click) of the e-mail is provided with the value 1, while a “non-response” is provided a value of 0. For example, USER 3 opened the Automobile Campaign (Campaign A), for a value of 0.5, opened the e-mail and “clicked” on the link therein to be redirected to the targeted web site for the Boat Campaign (Campaign B), for a value of 1, did not respond to the e-mail (a “non-response”) of the Carpet Campaign (Campaign C), for a value of 0, clicked on the link in the opened e-mail for the Dog Toys Campaign, for a value of 1, and did not respond to the Eggs Campaign, for a value of 0.

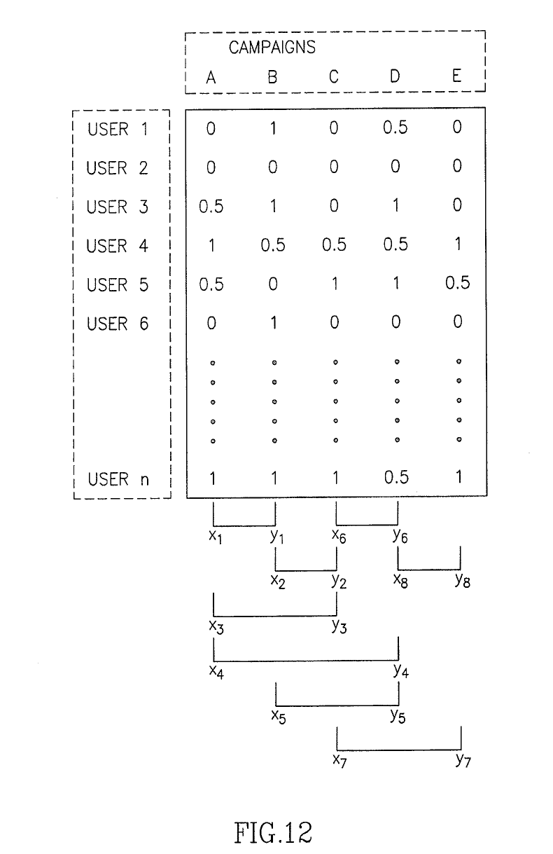

The charted responses of FIG. 11 are now converted into the data matrix of FIG. 12. The headings are shown in broken line boxes for explanation purposes only. This data matrix is an “m by n” matrix, where m represents the number of campaigns, here, for example, Campaigns A-E to be tested, and n represents the number of e-mail users, here, for example, e-mail users (USER 1 to USER n).

The second phase of the process now begins. In this second phase, the correlation between informational or advertising campaigns is determined, as a correlation value is determined for two campaigns. This correlation value provides an indication of the correlation between two campaigns.

Initially, a correlation coefficient will be determined between two campaigns, and each correlation coefficient will be analyzed for a lower confidence limit (LCL), a value that is calculated. This LCL value will be useful in determining which campaigns to send to which users (recipients), and will allow for a ranking of correlated campaigns for sending to users (recipients).

Turning to FIG. 12, correlations between two advertising campaigns are viewed in accordance with correlation vectors, paired as x and y and expressed as (x,y), for example, as (x₁, y₁), (x₂, y₂), (x₃, y₃), (x₄, y₄), (x₅, y₅), (x₆, y₆), (x₇, y₇), and x₈, y₈), as indicated at the matrix. These eight parings represent the eight different paired campaigns, remaining from FIG. 10C, are as follows: (A, B), (B, C), (A, C), (A, D), (B, D), (C, D), (C, E) and (D, E). These pairs, (A, B), (B, C), (A, C), (A, D), (B, D), (C, D), (C, E) and (D, E), correspond to the vector pairs, (x₁, y₁), (x₂, y₂), (x₃, y₂), (x₄, y₄), (x₅, y₅), (X₆, y₆), (X₇, y₇), and (x₈, y₈), as shown in FIG. 12.

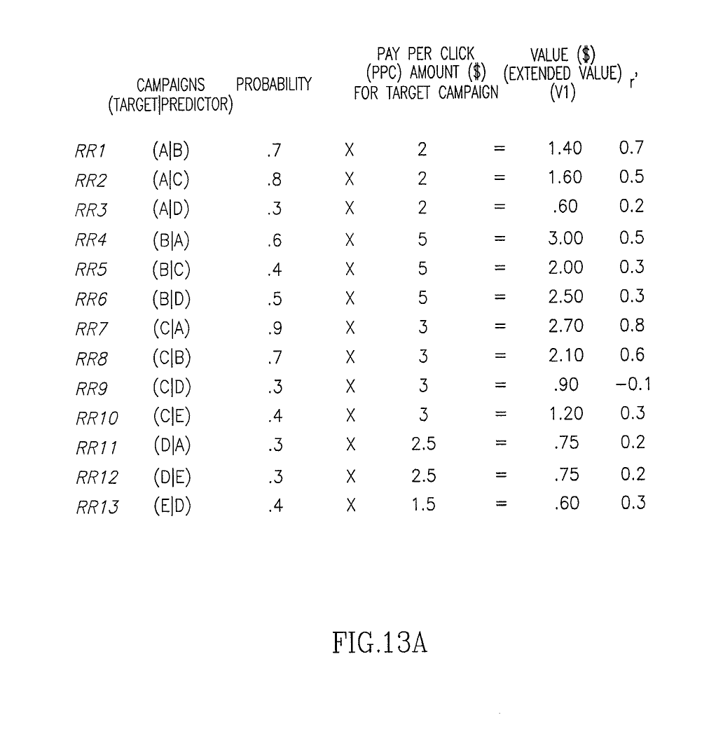

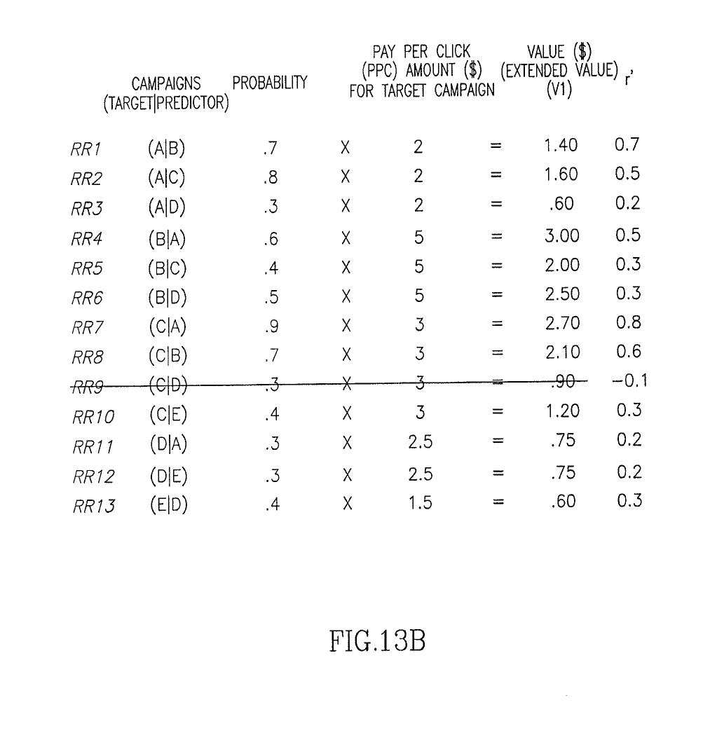

As discussed above, the correlation is represented by the correlation coefficient “r”. The correlation coefficient “r” is also known and referred to herein as a Pearson's Correlation Coefficient. The correlation coefficient “r” is a measure of the correlation among two vectors, x and y. The correlation coefficient “r” and the lower confidence limit LCL, represented by the value r′, are determined in accordance with STEP 1, STEP 2 and STEP 3, detailed above. LCL values, expressed as r′, are listed for the respective paired campaigns in FIG. 13A.

In FIG. 13A, the paired campaigns, indicated by RR9, have a negative value for r′. Accordingly, these paired campaigns are considered to be a “false positive” and not correlated, such that they are removed from the list, which is modified, resulting in the list of FIG. 13B. Since at least one target campaign A, B, C, D and E remains on the list of FIG. 13B, these paired campaigns RR1-RR8 and RR10-RR13, will now be subjected to the third phase of the process.

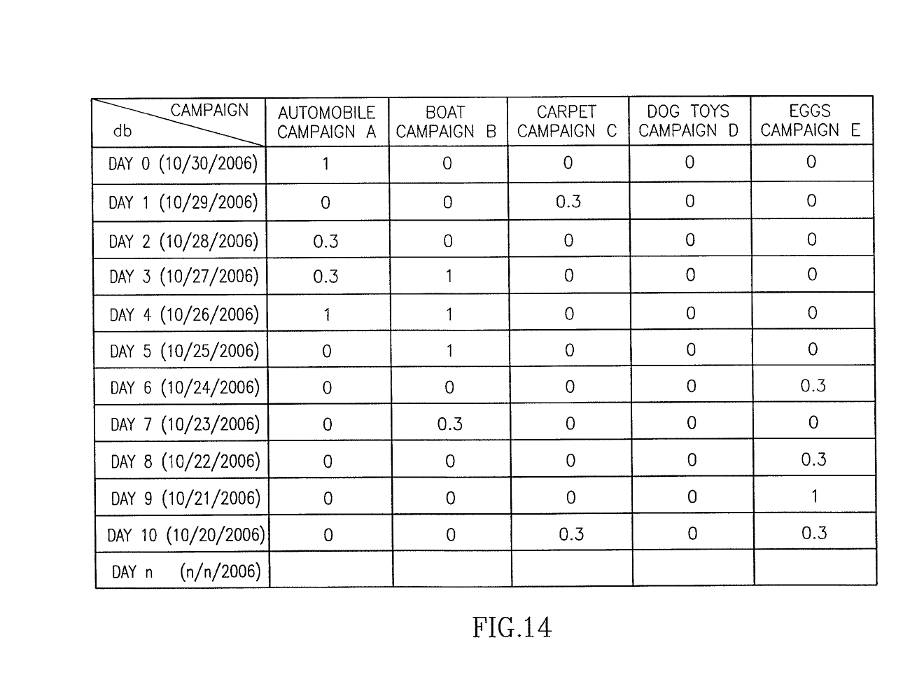

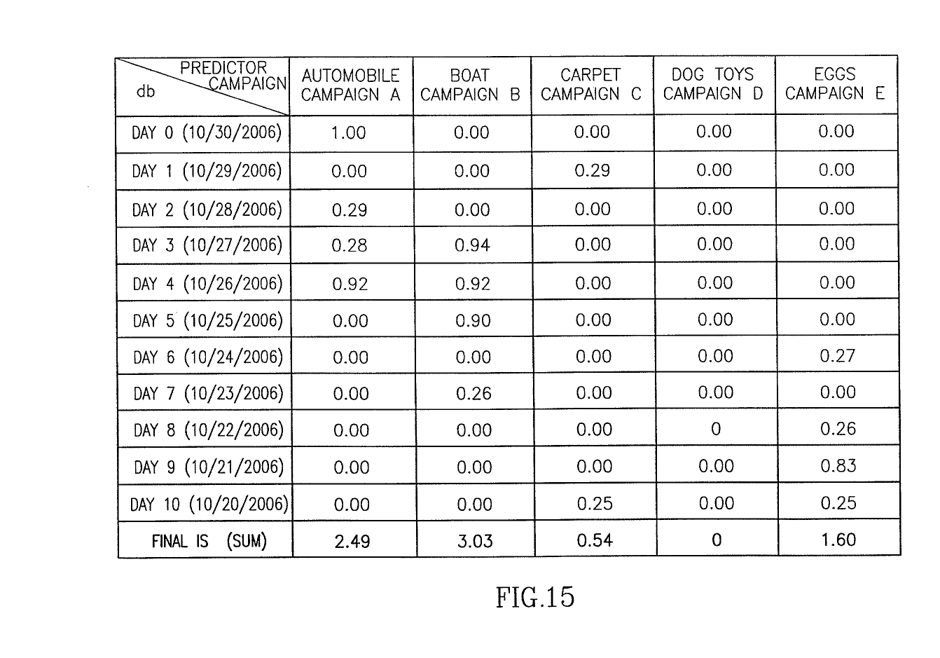

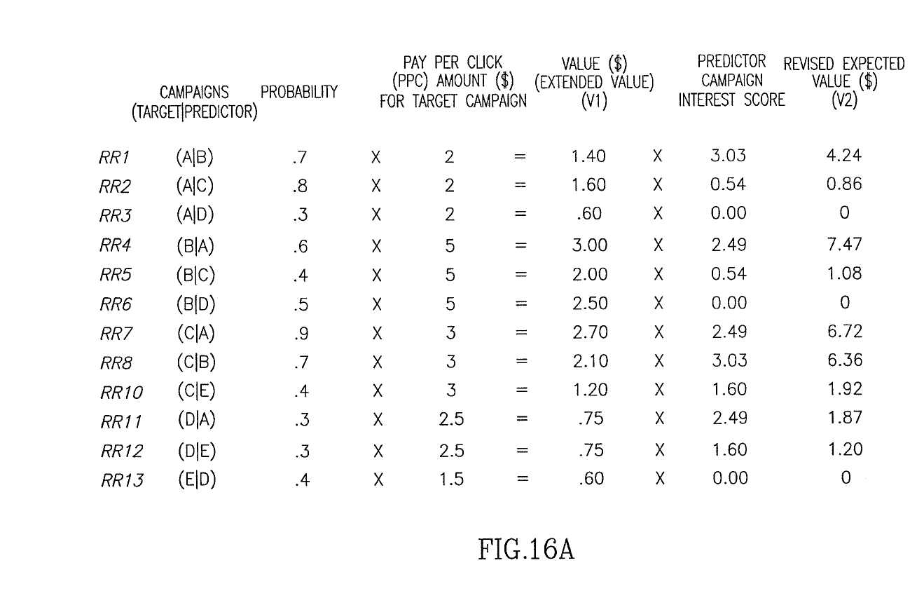

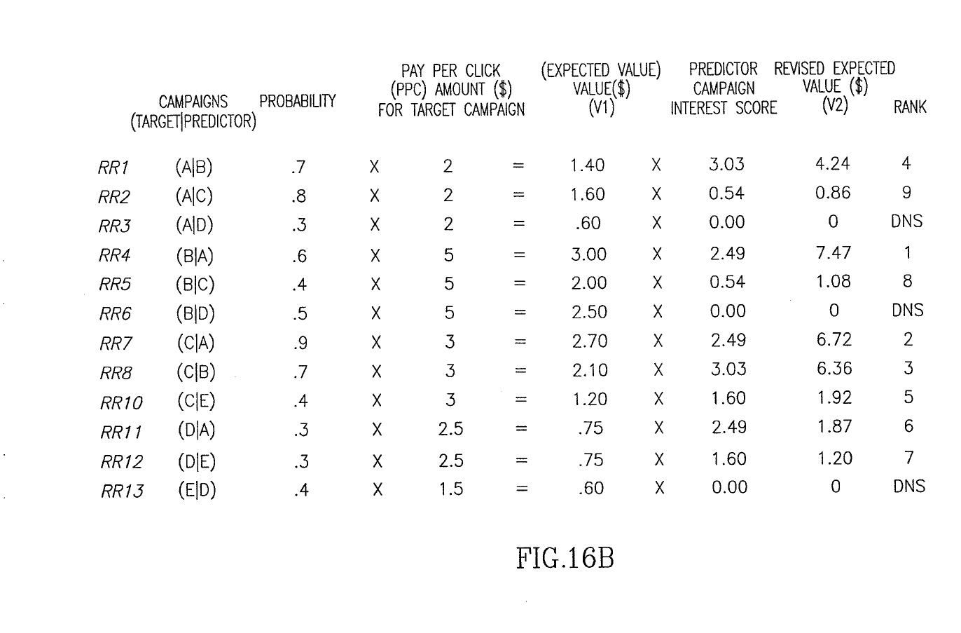

A third phase of the process occurs, as a User Interest Score (also known as a Total Interest Score) is determined for each campaign for each individual user. Based on this user interest score, the highest ranked target campaign will be determined (typically from a ranked ordered list), with the highest ranked target campaign sent, or designated to be sent, to the requisite user. Campaigns A through E have been sent to users (recipients), USER 1 to USER n, over the past ten days. The results of the responses to the campaigns, for USER 1, a particular user (recipient), are shown in the table of FIG. 14. USER 1 is representative of all users, and the table of FIG. 14 is applicable to all users. Similarly, FIGS. 15, 16A and 16B, are for USER 1, as also exemplary of a process applicable for all users.

As with the campaigns detailed above, the campaigns are sent as e-mail, with an “opening of the e-mail provided with a value of 0.3, a “click” (open with a click) of the e-mail is provided with the value 1, while a “non-response” is provided a value of 0. Also in this table, the “db” value is determined in accordance with predetermined time periods, for a current time, and when the e-mail for a campaign are responded to (responded or not responded to, responses including both “opens” and “clicks”, as detailed above). For example, the time period of FIGS. 14 and 15 is days (predetermined twenty four hour periods), whereby, “db” is the number of days back from the most recent day, the requisite e-mails for each campaign being sent on each day. Typically, a sample like that of the Table of FIG. 14 extends back 40 days, whereby n=40.

For example, taking 30 OCT 2006—Day 0 (expressed in FIGS. 14 and 15 in the form of 10/30/2006) as the current date (current time), and accordingly a db value of 0 (db=0) on 30 OCT 2006, USER 1 responded to Campaign A, the Automobile Campaign, by a “click”, hence, the value “1” in the corresponding box, but did not respond, neither “opening”, nor “clicking” on campaigns B through E. The value is 0. Continuing with this example, on 29 OCT 2006 (10/29/2006)—Day 1, db=1, and USER 1 did not respond to Campaigns A, B, D and E, for a value of 0 in the corresponding boxes. The user (User 1) “opened” Campaign C, hence, the value of 0.3 in the corresponding box.

An Interest Score (IS) is now determined for each campaign the Interest Score is determined in accordance with the formula:
IS=RV·0.98^{dbi} (T1)
where, RV is the Response Value, an assigned value for a non-response or a response to the e-mail for the requisite campaign, with the following assigned values: 0 for a “non-response”, 0.3 for a response that is an “open”, 1 for a response that is a “click” on the opened e-mail, and 0 for a non-response based on a time out or a predetermined time period lapsing, for example, one day, whereby 0 is the default value; and, dbi is the difference in time periods, typically days, between the current date (time period) and the date (time period) in which the user responded (“opened” or “clicked”), or non-responded, to the campaign.

Applying the formula for Interest Score (IS), the Interest Score for each box is calculated, with the calculations for the Table of FIG. 14, shown in the corresponding boxes in the corresponding table of FIG. 14. In FIG. 14, the Interest Scores (IS) for each predictor campaign (collectively IS_{dbi}_{_{—}}_{Campaign}) are added or summed, in accordance with the formula:

$${IS}_{Campaign} = {\sum }_{dbi} {IS}_{dbi\_Campaign} \qquad ( T 2 )$$

with the summation or sum being Total Value or Sum for each predictor campaign, expressed as IS_{Campaign}.

For example, in FIG. 15, for Predictor Campaign A, the Automobile Campaign, the Final IS (SUM) or IS_{Total(CampaignA)} is calculated using Formula T2, as follows:
IS_{Total(CampaignA)}=1.00+0.00+0.29+0.28+0.92+0.00+0.00+0.00+0.00+0.00+0.00 where, IS_{Total(CampaignA)}=2.49

Using the same formula, Formula T2, the Interest Score for Predictor Campaign B (the Boats Campaign) is 3.03, Predictor Campaign C (the Carpet Campaign) is 0.54, Predictor Campaign D (the dog Toys Campaign) is 0.00, and Predictor Campaign E (the Eggs Campaign) is 1.60, as shown in the lowermost row of FIG. 15.

The Total Interest Score, IS_{Total(campaign)}, for each predictor campaign, is returned to the Table of FIG. 10C and multiplied by the Expected Value (V1), to obtain a Revised Expected Value (V2), as shown in the Table of FIG. 16A. The paired campaigns from FIG. 16A are then ranked, for example, as ordered by their Expected Values (V2), with the rankings provided in the Table of FIG. 16B (in the right most column). The highest ranked campaign pair will be the best for sending the target campaign thereof. Campaigns labeled DNS for Do Not Send in FIG. 16B, will not be sent, or will not be designated for sending.

For example, in FIG. 16B the best target campaign to send (or designated to be sent) to USER 1 is Campaign B, the Boats Campaign, as it is the highest ranked (V2=7.47). While a particular campaign may be the highest ranked, there may be rules and policies in the system to send another target campaign. The actual target campaign sent, or designated to be sent, to the particular user (recipient) remains a function of the system and the system administrator.

### EXAMPLE 2

Attention is again directed to the first ten records of the data set (the Large Table Appendix-Appendix A) for users01-10, is listed in Table EX-A′ above. Specifically, the behavior of a particular user, user04 was analyzed. In analyzing user04, from Table EX-A′, an e-mail delivery with no response (not opened) is denoted with a value of 0. A delivery with an open but no click is denoted with a value of 0.3, while an e-mail delivery with an open and a click is denoted with a value of 1, such that user04, in the corresponding modified row of Table EX-A′ is expressed as Table EX-2.1, as follows:

TABLE EX-2.1
user04

| Art | | | | | | | | |
|---|---|---|---|---|---|---|---|---|
| Sup- | | | | Credit | Office | | | Vaca- |
| plies | Books | Boats | Cars | Cards | Supplies | Shoes | Toys | tions |
| 1 | 1 | 0.3 | 0.3 | 0.3 | 0 | 0 | 0 | 0 |

The historical behavior of user04 for the campaigns over a forty day period, where db values range from 0 to 40, is in accordance with the Table EX-2.1, as follows:

TABLE EX-2.2
User04
Historical Behavior to those campaigns:

| | Art | | | | Credit | Office | | | |
|---|---|---|---|---|---|---|---|---|---|
| db | Supplies | Books | Boats | Cars | Cards | Supplies | Shoes | Toys | Vacations |
| 0 | 0 | 1 | 0 | 0 | 0 | 0 | 0 | 0 | 0 |
| 1 | 0 | 0 | 0 | 0 | 0.3 | 0 | 0 | 0 | 0 |
| 2 | 0 | 0.3 | 0 | 0 | 0 | 0 | 0 | 0 | 0 |
| 3 | 0.3 | 0.3 | 0 | 0 | 0.3 | 0 | 0 | 0 | 0 |
| 4 | 0 | 0 | 0 | 0 | 0 | 0 | 0 | 0 | 0 |
| 5 | 0 | 0 | 0 | 0 | 0 | 0 | 0 | 0 | 0 |
| 6 | 0.3 | 0 | 0 | 0 | 0.3 | 0 | 0 | 0 | 0 |
| 7 | 0 | 0 | 0 | 0 | 0 | 0 | 0 | 0 | 0 |
| 8 | 0 | 0 | 0 | 0 | 0 | 0 | 0 | 0 | 0 |
| 9 | 0 | 0 | 0 | 0 | 0 | 0 | 0 | 0 | 0 |
| 10 | 0 | 0 | 0 | 0 | 0 | 0 | 0 | 0 | 0 |
| 11 | 0 | 0.3 | 0 | 0 | 0 | 0 | 0 | 0 | 0 |
| 12 | 0 | 0 | 0 | 0 | 0 | 0 | 0 | 0 | 0 |
| 13 | 0.3 | 0 | 0 | 0 | 0 | 0 | 0 | 0 | 0 |
| 14 | 0 | 0 | 0 | 0 | 0 | 0 | 0 | 0 | 0 |
| 15 | 0 | 0 | 0 | 0 | 0 | 0 | 0 | 0 | 0 |
| 16 | 0 | 0 | 0 | 0 | 0 | 0 | 0 | 0 | 0 |
| 17 | 0 | 0 | 0 | 0 | 0 | 0 | 0 | 0 | 0 |
| 18 | 0 | 0 | 0 | 0 | 0 | 0 | 0 | 0 | 0 |
| 19 | 0 | 0 | 0 | 0 | 0 | 0 | 0 | 0 | 0 |
| 20 | 0 | 0 | 0 | 0 | 0 | 0 | 0 | 0 | 0 |
| 21 | 0 | 0 | 0 | 0 | 0 | 0 | 0 | 0 | 0 |
| 22 | 0 | 0 | 0 | 0 | 0 | 0 | 0 | 0 | 0 |
| 23 | 0 | 0 | 0 | 0 | 0 | 0 | 0 | 0 | 0 |
| 24 | 0 | 0 | 0 | 0 | 0 | 0 | 0 | 0 | 0 |
| 25 | 1 | 0 | 0 | 0 | 0 | 0 | 0 | 0 | 0 |
| 26 | 0 | 0 | 0 | 0 | 0 | 0 | 0 | 0 | 0 |
| 27 | 0 | 0 | 0 | 0 | 0 | 0 | 0 | 0 | 0 |
| 28 | 0 | 0 | 0 | 0 | 0 | 0 | 0 | 0 | 0 |
| 29 | 0 | 0 | 0 | 0 | 0 | 0 | 0 | 0 | 0 |
| 30 | 0 | 0 | 0 | 0.3 | 0 | 0 | 0 | 0 | 0 |
| 31 | 0 | 0 | 0 | 0 | 0 | 0 | 0 | 0 | 0 |
| 32 | 0 | 0 | 0 | 0 | 0 | 0 | 0 | 0 | 0 |
| 33 | 0 | 0 | 0 | 0 | 0 | 0 | 0 | 0 | 0 |
| 34 | 0 | 0 | 0 | 0 | 0 | 0 | 0 | 0 | 0 |
| 35 | 1 | 0 | 0 | 0 | 0 | 0 | 0 | 0 | 0 |
| 36 | 0 | 0 | 0.3 | 0 | 0 | 0 | 0 | 0 | 0 |
| 37 | 0 | 0 | 0 | 0.3 | 0 | 0 | 0 | 0 | 0 |
| 38 | 0 | 0 | 0 | 0 | 0 | 0 | 0 | 0 | 0 |
| 39 | 1 | 0 | 0 | 0 | 0 | 0 | 0 | 0 | 0 |
| 40 | 0 | 0 | 0 | 0 | 0 | 0 | 0 | 0 | 0 |

Formula T1 above was applied to all of the values in Table EX-2.2, with the Interest Scores for each box of Table EX-2.2 in the corresponding box of Table EX-2.3, and the last row of Table EX-2.3 is the Total Interest Score of user04 for each campaign, expressed as IS_{Total(Campaign)} in accordance with Formula T2 above, resulting in Table EX-2.3 as follows:

TABLE EX-2.3
User04
Interest Score to the campaigns:

| | Art | | | | Credit | Office | | | |
|---|---|---|---|---|---|---|---|---|---|
| db | Supplies | Books | Boats | Cars | Cards | Supplies | Shoes | Toys | Vacations |
| 0 | 0 | 1 | 0 | 0 | 0 | 0 | 0 | 0 | 0 |
| 1 | 0 | 0 | 0 | 0 | 0.294 | 0 | 0 | 0 | 0 |
| 2 | 0 | 0.28812 | 0 | 0 | 0 | 0 | 0 | 0 | 0 |
| 3 | 0.282358 | 0.282358 | 0 | 0 | 0.282358 | 0 | 0 | 0 | 0 |
| 4 | 0 | 0 | 0 | 0 | 0 | 0 | 0 | 0 | 0 |
| 5 | 0 | 0 | 0 | 0 | 0 | 0 | 0 | 0 | 0 |
| 6 | 0.265753 | 0 | 0 | 0 | 0.265753 | 0 | 0 | 0 | 0 |
| 7 | 0 | 0 | 0 | 0 | 0 | 0 | 0 | 0 | 0 |
| 8 | 0 | 0 | 0 | 0 | 0 | 0 | 0 | 0 | 0 |
| 9 | 0 | 0 | 0 | 0 | 0 | 0 | 0 | 0 | 0 |
| 10 | 0 | 0 | 0 | 0 | 0 | 0 | 0 | 0 | 0 |
| 11 | 0 | 0.240219 | 0 | 0 | 0 | 0 | 0 | 0 | 0 |
| 12 | 0 | 0 | 0 | 0 | 0 | 0 | 0 | 0 | 0 |
| 13 | 0.230707 | 0 | 0 | 0 | 0 | 0 | 0 | 0 | 0 |
| 14 | 0 | 0 | 0 | 0 | 0 | 0 | 0 | 0 | 0 |
| 15 | 0 | 0 | 0 | 0 | 0 | 0 | 0 | 0 | 0 |
| 16 | 0 | 0 | 0 | 0 | 0 | 0 | 0 | 0 | 0 |
| 17 | 0 | 0 | 0 | 0 | 0 | 0 | 0 | 0 | 0 |
| 18 | 0 | 0 | 0 | 0 | 0 | 0 | 0 | 0 | 0 |
| 19 | 0 | 0 | 0 | 0 | 0 | 0 | 0 | 0 | 0 |
| 20 | 0 | 0 | 0 | 0 | 0 | 0 | 0 | 0 | 0 |
| 21 | 0 | 0 | 0 | 0 | 0 | 0 | 0 | 0 | 0 |
| 22 | 0 | 0 | 0 | 0 | 0 | 0 | 0 | 0 | 0 |
| 23 | 0 | 0 | 0 | 0 | 0 | 0 | 0 | 0 | 0 |
| 24 | 0 | 0 | 0 | 0 | 0 | 0 | 0 | 0 | 0 |
| 25 | 0.603465 | 0 | 0 | 0 | 0 | 0 | 0 | 0 | 0 |
| 26 | 0 | 0 | 0 | 0 | 0 | 0 | 0 | 0 | 0 |
| 27 | 0 | 0 | 0 | 0 | 0 | 0 | 0 | 0 | 0 |
| 28 | 0 | 0 | 0 | 0 | 0 | 0 | 0 | 0 | 0 |
| 29 | 0 | 0 | 0 | 0 | 0 | 0 | 0 | 0 | 0 |
| 30 | 0 | 0 | 0 | 0.163645 | 0 | 0 | 0 | 0 | 0 |
| 31 | 0 | 0 | 0 | 0 | 0 | 0 | 0 | 0 | 0 |
| 32 | 0 | 0 | 0 | 0 | 0 | 0 | 0 | 0 | 0 |
| 33 | 0 | 0 | 0 | 0 | 0 | 0 | 0 | 0 | 0 |
| 34 | 0 | 0 | 0 | 0 | 0 | 0 | 0 | 0 | 0 |
| 35 | 0.493075 | 0 | 0 | 0 | 0 | 0 | 0 | 0 | 0 |
| 36 | 0 | 0 | 0.144964 | 0 | 0 | 0 | 0 | 0 | 0 |
| 37 | 0 | 0 | 0 | 0.142065 | 0 | 0 | 0 | 0 | 0 |
| 38 | 0 | 0 | 0 | 0 | 0 | 0 | 0 | 0 | 0 |
| 39 | 0.454796 | 0 | 0 | 0 | 0 | 0 | 0 | 0 | 0 |
| 40 | 0 | 0 | 0 | 0 | 0 | 0 | 0 | 0 | 0 |
| IS SUM | 2.3302 | 1.8107 | 0.1450 | 0.3057 | 0.8421 | 0.0000 | 0.0000 | 0.0000 | 0.0000 |

Based on Table EX-B3, user04 has the greatest interest in the Art Supplies Campaign, followed by the Books Campaign, the Credit Cards Campaign, the Cars Campaign, and the Boats Campaign. The user does not show interest in the Office Supplies Campaign, Shoes Campaign, Toys Campaign, and Vacations Campaign, based on their scores of 0.000. The Art Supplies Campaign, followed by the Books Campaign, the Credit Cards Campaign, the Cars Campaign, and the Boats Campaign, will be further analyzed.

The Total Interest Score, IS_{Total(Campaign)} is analyzed in accordance with the analysis of the Table of FIG. 10C, as detailed above. The Campaigns will be ranked, and user04 will be sent the requisite campaign, typically based on the ranking.

The above-described processes including portions thereof can be performed by software, hardware and combinations thereof. These processes and portions thereof can be performed by computers, computer-type devices, workstations, processors, micro-processors, other electronic searching tools and memory and other storage-type devices associated therewith. The processes and portions thereof can also be embodied in programmable storage devices, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While preferred embodiments of the present disclosed subject matter have been described, so as to enable one of skill in the art to practice the present disclosed subject matter, the preceding description is intended to be exemplary only. It should not be used to limit the scope of the disclosed subject matter, which should be determined by reference to the following claims.

What is claimed is:

1. A method for determining at least one informational campaign for a recipient comprising:
determining the conditional probability between a target campaign and a predictor campaign pair, for a plurality of target campaigns and a plurality of predictor campaigns;
determining the expected value of each campaign pair as a function of:
the conditional probability; and,
a first predetermined value for the target campaign;
determining a correlation value for each campaign pair; and,
determining a user interest score for each predictor campaign of the predictor campaigns in the existing campaign pairs.

2. The method of claim 1, additionally comprising:
determine a revised expected value for each predictor campaign as a function of the expected value and the user interest score.

3. The method of claim 2, additionally comprising ranking the existing campaign pairs in an order based on their revised expected values.

4. The method of claim 3, additionally comprising sending at least one target campaign from the ranked campaign pairs to a recipient.

5. The method of claim 4, wherein sending the at least one target campaign includes sending the target campaign of the campaign pair that has the highest rank.

6. The method of claim 1, wherein determining the conditional probability includes determining the probability that the recipient who has responded to a predictor campaign will respond to a target campaign sent to the recipient based on the response to the predictor campaign.

7. The method of claim 6, wherein the response to the predictor campaign includes at least opening a communication containing the campaign, and a response to the target campaign includes a click or other activation where the recipient, through a browsing application, is directed to a target web site.

8. The method of claim 7, wherein the response to the predictor campaign includes a click or other activation where the recipient, through a browsing application, is directed to a target web site.

9. The method of claim 1, wherein determining the expected value of each campaign pair additionally comprises, selecting select target and predictor campaign pairs in accordance with a second predetermined value.

10. The method of claim 9, wherein the first predetermined value includes a pay per click amount.

11. The method of claim 10, wherein the second predetermined value includes an assigned minimum expected value.

12. The method of claim 1, wherein determining the correlation value for each campaign pair includes determining the correlation value as a function of the Pearson's Correlation Coefficient.

13. The method of claim 12, wherein determining the correlation value additionally includes selecting campaign pairs with having a Pearson's Correlation Coefficient above a third predetermined value.

14. The method of claim 13, wherein the third predetermined value is a positive value.

15. The method of claim 1, wherein the at least one informational campaign, the plurality of target campaigns and the plurality of predictor campaigns are advertising campaigns.

16. A system for determining at least one informational campaign for a recipient comprising:
a storage device; and,
a processor programmed to:
maintain in the storage device a database a list of a plurality of target campaigns and a plurality of predictor campaigns;
determine the conditional probability between a target campaign and a predictor campaign pair, for the plurality of target campaigns and the plurality of predictor campaigns;
determine the expected value of each campaign pair as a function of:
the conditional probability; and,
a first predetermined value for the target campaign;
determine a correlation value for each campaign pair; and,
determine a user interest score for each predictor campaign of the predictor campaigns in the existing campaign pairs.

17. The system of claim 16, wherein the processor is additionally programmed to:
determine a revised expected value for each predictor campaign as a function of the expected value and the user interest score.

18. The system of claim 17, wherein the processor is additionally programmed to rank the existing campaign pairs in an order based on their revised expected values.

19. The system of claim 18, wherein the processor is additionally programmed to send at least one target campaign from the ranked campaign pairs to a recipient.

20. The system of claim 19, wherein the processor programmed to send the at least one target campaign is additionally programmed to send the target campaign of the campaign pair that has the highest rank.

21. The system of claim 16, wherein the processor programmed to determine the conditional probability is additionally programmed to determine the probability that the recipient who has responded to a predictor campaign will respond to a target campaign sent to the recipient based on the response to the predictor campaign.

22. The system of claim 21, wherein the processor programmed to determine the response to the predictor campaign is additionally programmed to:
record at least an opening of a communication containing the campaign, and,
record at least a response to the target campaign that includes a click or other activation where the recipient, through a browsing application, is directed to a target web site.

23. The system of claim 21, wherein the processor programmed to record the response to the predictor campaign is additionally programmed to record a click or other activation where the recipient, through a browsing application, is directed to a target web site.

24. The system of claim 16, wherein the processor programmed to determine the expected value of each campaign pair is additionally programmed to: select target and predictor campaign pairs in accordance with a second predetermined value.

25. The system of claim 24, wherein the first predetermined value includes a pay per click amount.

26. The system of claim 25, wherein the second predetermined value includes an assigned minimum expected value.

27. The system of claim 16, wherein the processor programmed to determine the correlation value for each campaign pair, is additionally programmed to determine the correlation value as a function of the Pearson's Correlation Coefficient.

28. The system of claim 27, wherein the processor programmed to determine the correlation value is additionally programmed to select campaign pairs with having a Pearson's Correlation Coefficient above a third predetermined value.

29. The system of claim 28, wherein the third predetermined value is a positive value.

30. The system of claim 16, wherein the storage device and processor are located on a single server.

31. The system of claim 16, wherein the at least one informational campaign, the plurality of target campaigns and the plurality of predictor campaigns are advertising campaigns.

32. A computer-usable storage medium having a computer program embodied thereon for causing a suitably programmed system to determine at least one informational campaign for a recipient, by performing the following steps when such program is executed on the system, the steps comprising:
determining the conditional probability between a target campaign and a predictor campaign pair, for a plurality of target campaigns and a plurality of predictor campaigns;
determining the expected value of each campaign pair as a function of:
the conditional probability; and,
a first predetermined value for the target campaign;
determining a correlation value for each campaign pair; and,
determining a user interest score for each predictor campaign of the predictor campaigns in the existing campaign pairs.

33. The computer usable storage medium of claim 32, wherein the steps additionally comprise:
determining a revised expected value for each predictor campaign as a function of the expected value and the user interest score.

34. The computer usable storage medium of claim 33, wherein the steps additionally comprise:
ranking the existing campaign pairs in an order based on their revised expected values.

35. The computer usable storage medium of claim 34, wherein the steps additionally comprise:
sending at least one target campaign from the ranked campaign pairs to a recipient.

36. The computer usable storage medium of claim 35, wherein sending the at least one target campaign includes sending the target campaign of the campaign pair that has the highest rank.

37. The computer usable storage medium of claim 32, wherein determining the conditional probability includes determining the probability that the recipient who has responded to a predictor campaign will respond to a target campaign sent to the recipient based on the response to the predictor campaign.

38. The computer usable storage medium of claim 37, wherein the response to the predictor campaign includes at least opening a communication containing the campaign, and a response to the target campaign includes a click or other activation where the recipient, through a browsing application, is directed to a target web site.

39. The computer usable storage medium of claim 38, wherein the response to the predictor campaign includes a click or other activation where the recipient, through a browsing application, is directed to a target web site.

40. The computer usable storage medium of claim 32, wherein determining the expected value of each campaign pair additionally comprises, selecting select target and predictor campaign pairs in accordance with a second predetermined value.

41. The computer usable storage medium of claim 40, wherein the first predetermined value includes a pay per click amount.

42. The computer usable storage medium of claim 41, wherein the second predetermined value includes an assigned minimum expected value.

43. The computer usable storage medium of claim 32, wherein determining the correlation value for each campaign pair includes determining the correlation value as a function of the Pearson's Correlation Coefficient.

44. The computer usable storage medium of claim 43, wherein determining the correlation value additionally includes selecting campaign pairs with having a Pearson's Correlation Coefficient above a third predetermined value.

45. The computer usable storage medium of claim 44, wherein the third predetermined value is a positive value.

46. The computer usable storage medium of claim 32, wherein the at least one informational campaign, the plurality of target campaigns and the plurality of predictor campaigns are advertising campaigns.
